(19) United States
(12) Patent Application Publication
(10) Pub. No.: US 2004/0054069 A1
(43) Pub. Date: Mar. 18, 2004

(54) Polyvinyl alcohol and method for producing polyvinyl alcohol

(75) Inventors: Takeshi Kusudou, Okayama-Pref. (JP); Atsushi Jikihara, Okayama-Pref. (JP); Naoki Fujiwara, Okayama-Pref. (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kurary Co., Ltd., Kurashiki-City (JP)

(21) Appl. No.: 10/617,190

(22) Filed: Jul. 11, 2003

(30) Foreign Application Priority Data
Jul. 11, 2002 (JP) 203146/2002

(51) Int. Cl. C08K 3/00

(52) U.S. Cl. 524/557

(57) ABSTRACT

A polyvinyl alcohol obtained by hydrolysis of a polyvinyl ester that contains silyl group functionalized monomer units. The polyvinyl alcohol satisfies the following formula (I) and the weight fraction of the polymer molecules contained in the polyvinyl alcohol having the degree of polymerization that is more than 3 times the weight-average degree of polymerization of the whole polyvinyl alcohol molecules is at most 25% by weight:

20<Pw×S<460 (I)

wherein Pw is the weight-average degree of polymerization of the polyvinyl alcohol, and S is the content (mol %) of the silyl group functionalized monomer units. The polyvinyl alcohol is readily dissolved in water without need for addition of an alkali or an acid; the aqueous solution have good viscosity stability; film formed of its aqueous solution have excellent water resistance; the binding force with inorganic substances is high; and a film mixture of the polyvinyl alcohol with an inorganic substance has excellent water resistance. The polyvinyl alcohol is favorable for coating agents for inkjet recording materials and thermal recording materials.

### BACKGROUND OF THE INVENTION

1. Field of the Invention

The present invention relates to a polyvinyl alcohol (i.e. vinyl alcohol-based polymer). More precisely, the invention relates to a silyl group functionalized polyvinyl alcohol, which may be readily dissolved in water to form aqueous solutions without the addition of an alkali such as sodium hydroxide or an acid, and whose aqueous solutions have good viscosity stability. Films derived from the aqueous solutions have excellent water resistance. The binding force of the polyvinyl alcohol with inorganic substances is high and films containing a mixture of the polyvinyl alcohol and an inorganic substance have excellent water resistance.

The invention also relates to a method for producing the polyvinyl alcohol. The invention further relates to a coating agent that contains the polyvinyl alcohol, and to coated products such as inkjet recording materials and thermal recording materials fabricated by applying the coating agent to a substrate.

2. Description of the Related Art

Vinyl alcohol-based polymers such as polyvinyl alcohols (hereinafter abbreviated as PVA) are known water-soluble synthetic polymers that may be used as a starting material for the synthetic fiber vinylon. PVA is also widely used in other fields such as paper processing, fiber processing, adhesives, stabilizers in emulsion polymerization and suspension polymerization, binders for inorganic substances, films, etc. As compared with other synthetic polymers, PVA is especially desirable for its mechanical strength and film-forming ability, and based on such its characteristics PVA is favorably used in clear coating agents that improve the surface characteristics of paper or binders in pigment coating.

Various attempts have been made to modify PVA and expand its use to other applications. One way is to introduce silicon (e.g., in the form of silyl groups) into PVA. A silyl group functionalized PVA provides excellent water-resistance and has excellent reactivity and adhesiveness to inorganic substances. For example, a method is known for producing silyl group functionalized PVA which comprises dissolving a silylating agent such as triethylchlorosilane in an organic solvent then adding a powdery PVA thereto and reacting them with stirring (JP-A 55-164614). However, the method is problematic in that it provides a homogeneously modified product only with difficulty and requires an additional step of reacting the PVA with a silylating agent in addition to the PVA production itself. From the industrial viewpoint, therefore, the method is impracticable.

Other methods of silyl group functionalized PVA production free from these problems have been proposed. For example, one method comprises hydrolyzing a copolymer of a vinyl alkoxysilane such as vinyltriethoxysilane and vinyl acetate (JP-A 50-123189); another method comprises hydrolyzing a copolymer of a silyl group functionalized acrylamide derivative and a vinyl ester such as vinyl acetate (JP-A 58-59203); still another method comprises hydrolyzing a copolymer of a specifically-substituted silyl group functionalized monomer and a vinyl ester (JP-A 58-79003); and still another method comprises hydrolyzing a copolymer of a silyl group functionalized allyl monomer and a vinyl ester (JP-A 58-164604).

However, the silyl group functionalized PVAs obtained in these methods have problems including (a) in preparing an aqueous solution of the silyl group functionalized PVA, some of the silyl group functionalized PVAs do not dissolve in water unless an alkali such as sodium hydroxide or an acid is present; (b) the viscosity stability of the aqueous solution of the silyl group functionalized PVA is not good; (c) the water-resistance of films formed of the aqueous solution of the silyl group functionalized PVA is not good; and (d) when films that contain the silyl group functionalized PVA and an inorganic substance are formed, they can not simultaneously provide sufficient binding force between the polymer and the inorganic substance and water-resistance.

An ionic hydrophilic group functionalized, silyl group functionalized PVA has been proposed (JP-A 59-182803); and it is reported that a PVA having a silanol group in its side branches has a strong interactivity with inorganic substances (Journal of the Chemical Society of Japan, 1994, (4), 365-370). However, even these modified PVAs do not solve the above-mentioned problems (a) to (d).

An object of the invention is to provide a silyl group functionalized polyvinyl alcohol which may be readily dissolved in water to form an aqueous solution without adding an alkali such as sodium hydroxide or an acid thereto; whose aqueous solutions have good viscosity stability; films of the aqueous solution have excellent water resistance; the binding force with inorganic substances is high; and films containing a mixture of the polyvinyl alcohol and an inorganic substance have excellent water resistance.

The invention also relates to a method for producing the polyvinyl alcohol. The invention further relates to a coating agent that contains the polyvinyl alcohol, and to coated products such as inkjet recording materials and thermal recording materials fabricated by applying the coating agent to a substrate.

### SUMMARY OF THE INVENTION

A silyl group functionalized polyvinyl alcohol that satisfies specific requirements may be readily dissolved in water to form aqueous solutions without adding an alkali such as sodium hydroxide or an acid; the aqueous solutions thereof have good viscosity stability; films of the aqueous solutions have excellent water resistance; the binding force of the polyvinyl alcohol with inorganic substances is high; and films containing a mixture of the polyvinyl alcohol and one or more inorganic substances are resistant to water. Specifically, the invention includes a polyvinyl alcohol, which is obtained through hydrolysis of a polyvinyl ester that contains silyl group functionalized monomer units of formula (1):

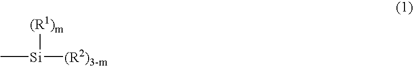

wherein R¹ represents an alkyl group having from 1 to 5 carbon atoms; R² represents an alkoxyl or acyloxyl group optionally having an oxygen-containing substituent; and m indicates an integer of from 0 to 2,

which satisfies the following formula (I):

20<Pw×S<460 (I)

wherein Pw indicates the weight-average degree of polymerization of the polyvinyl alcohol; S indicates the content (mol %) of the silyl group functionalized monomer units of formula (1) in the polyvinyl alcohol,

and in which the weight fraction of the polymer molecules having the degree of polymerization that are more than 3 times the weight-average degree of polymerization of the whole polyvinyl alcohol molecules is at most 25% by weight.

### DETAILED DESCRIPTION OF EMBODIMENTS OF THE INVENTION

The polyvinyl alcohol of the invention is obtained through hydrolysis of a polyvinyl ester that contains silyl group functionalized monomer units of the following formula (1):

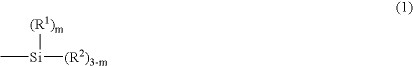

wherein R¹ represents an alkyl group having from 1 to 5 carbon atoms; R² represents an alkoxyl or acyloxyl group optionally having an oxygen-containing substituent; and m indicates an integer of from 0 to 2,

and must satisfy the following formula (I):

20<Pw×S<460 (I)

wherein Pw indicates the weight-average degree of polymerization of the polyvinyl alcohol; S indicates the content (mol %) of the silyl group functionalized monomer units of formula (1) in the polyvinyl alcohol,

further, the weight fraction of the polymer molecules having degree of polymerization that are more than 3 times the weight-average degree of polymerization of the whole polyvinyl alcohol molecules must be at most 25% by weight.

The polyvinyl alcohol of the invention must satisfy the relationship of 20<Pw×S<460, in which (Pw×S) is a product of the weight-average degree of polymerization (Pw) of the polyvinyl alcohol and the content (S) of the silyl group functionalized monomer units. Preferably, Pw×S satisfies the relationship of 50<Pw×S<420, more preferably 100<Pw×S<390. If Pw×S is 20 or less, then the water-resistance of the film formed of or derived from an aqueous solution of the silyl group functionalized PVA may be poor; but if Pw×S is 460 or more, then the silyl group functionalized PVA may not dissolve in water without the addition of an alkali.

If the weight fraction of the polyvinyl alcohol molecules having a degree of polymerization that is more than 3 times the weight-average degree of polymerization of the whole polyvinyl alcohol molecules is over 25% by weight, then the viscosity stability of an aqueous solution of the polyvinyl alcohol may be too low and, in addition, a homogeneous aqueous solution of the polyvinyl alcohol with an inorganic substance can not be prepared.

One explanation of why the viscosity stability of the aqueous solution of the polyvinyl alcohol may be lower when the weight fraction of the polyvinyl alcohol molecules having a degree of polymerization that is more than 3 times the weight-average degree of polymerization of the whole polyvinyl alcohol molecules is over 25% by weight, is as follows:

Of all the monomer units that constitute the silyl group functionalized polymer, the silyl group functionalized monomer units are present uniformly in the polymer. Therefore, a polymer having a larger degree of polymerization may have a larger number of the silyl group functionalized monomer units in one molecule. In the case where the number of the silyl group functionalized monomer units in one molecule of the polymer is larger, the polymer may be more influenced by silyl groups. Specifically, the polymer having a larger degree of polymerization is more influenced by silyl groups than a polymer having a smaller degree of polymerization. Accordingly, the polyvinyl alcohol that contains a larger amount of polymer having high degree of polymerization contains a larger amount of polymer that is more influenced by silyl groups, and, as a result, the viscosity stability of the aqueous solution of the polyvinyl alcohol may be lower.

The polymer having a smaller degree of polymerization may have a smaller number of the silyl group functionalized monomer units in one molecule. In the case where the number of the silyl group functionalized monomer units in one molecule of the polymer is smaller, the polymer may be less influenced by silyl groups. Specifically, the polymer having a smaller degree of polymerization may not be able to benefit from the effect of the silyl groups therein in comparison to a polymer having a larger degree of polymerization. Accordingly, a polyvinyl alcohol having a larger amount of polymer having a low degree of polymerization contains a larger amount of polymer in which the effect of the silyl groups is lower.

Preferably, in the polyvinyl alcohol of the invention, the weight fraction of the polymer molecules having a degree of polymerization that is smaller than ½ times the weight-average degree of polymerization Pw of the whole polyvinyl alcohol molecules is at most 12% by weight. In the polyvinyl alcohol of the invention, when the weight fraction of the polymer molecules having a degree of polymerization that is smaller than ½ times the weight-average degree of polymerization of the whole polyvinyl alcohol molecules is larger than 12% by weight, then the polyvinyl alcohol contains a large amount of polymer having a low degree of polymerization, which consequently does not exhibit the good effect of the silyl groups therein. Therefore, when a film of the polyvinyl alcohol and an inorganic substance is formed, its water-resistance and the binding force of the polymer with the inorganic substance may be low.

The weight-average degree of polymerization (Pw) and the distribution of polymerization degree of the polyvinyl alcohol may be obtained through GPC-LALLS analysis. The silyl group functionalized PVA is re-hydrolyzed to a degree of hydrolysis of at least 99.5%, then purified, and thereafter subjected to GPC-LALLS analysis to obtain the weight-average molecular weight of the polymer, and this is divided by the formula weight of the vinyl alcohol monomer unit, 44 to obtain the weight-average degree of polymerization of the polymer. In addition, from the integral distribution of polymerization degree obtained through the GPC-LALLS analysis, the weight fraction of the polymer molecules having a degree of polymerization within the specified range may be obtained.

In the polyvinyl alcohol of the invention, the content S (mol %) of the silyl group functionalized monomer units may be obtained through proton NMR of the corresponding polyvinyl ester before hydrolysis. Prior to its proton NMR, the polyvinyl ester before hydrolysis is purified through reprecipitation with hexane-acetone to completely remove the unreacted silyl group functionalized monomer from the polymer, and then dried at 90° C. under reduced pressure for 2 days, and thereafter dissolved in CDCl₃ and subjected to the analysis.

Preferably, the polyvinyl alcohol of the invention satisfies the following formula (II), and the pH of its aqueous 4% solution falls between 4 and 8.

0.1/100≦(A−B)/(B)≦50/100 (II)

wherein A indicates the silicon atom content (unit: ppm) of the polyvinyl alcohol,

B indicates the silicon atom content (unit: ppm) of the polyvinyl alcohol that has been washed with sodium hydroxide-containing methanol and then washed through Soxhlet extraction with methanol.

In the above, A and B are measured by ashing a sample of the polyvinyl alcohol and subjecting it to ICP emission spectrometry.

Preferably, the range of(A−B)/(B) falls between 0.1/100 and 50/100, more preferably between 0.3/100 and 25/100, even more preferably between 0.4/100 and 20/100. If the ratio (A−B)/(B) is over 50/100, it is unfavorable since the viscosity stability of the aqueous solution of the silyl group functionalized PVA may lower and it may be impossible to prepare a homogeneous aqueous solution of the silyl group functionalized PVA with an inorganic substance. If (A−B)/(B) is smaller than 0.1/100, then it is impracticable since the water-resistance of the film formed of the silyl group functionalized PVA with an inorganic substance and the binding force of the silyl group functionalized PVA with the inorganic substance in the film may be low and, in addition, the washing cost of the polyvinyl alcohol of which the ratio (A−B)/(B) is smaller than 0.1/100 is high in producing the polymer.

In obtaining the silicon atom content (B) of the polyvinyl alcohol, one standard method of washing the polymer comprises washing the polymer with sodium hydroxide-containing methanol at least five times (the washing operation comprises adding 10 parts by weight of a sodium hydroxide-containing methanol solution to one part by weight of the polyvinyl alcohol to such a degree that the molar ratio of sodium hydroxide to the vinyl alcohol monomer units of the polyvinyl alcohol may be 0.01, then boiling the resulting mixture for one hour and separating the polymer through filtration), and then subjecting the thus-washed polymer to Soxhlet extraction with methanol for one week. In the washing process, the washing operation with sodium hydroxide-containing methanol and the Soxhlet extraction with methanol are washed until the silicon atom content of the thus-processed polyvinyl alcohol no longer varies significantly. Within the range that satisfies the condition, the frequency of the washing operation with sodium hydroxide-containing methanol and the duration of the Soxhlet extraction with methanol may be suitably changed.

It may be considered that the silicon atom content (A) of the polyvinyl alcohol may be the overall silicon atom content of the polyvinyl alcohol. On the other hand, it may be considered that the silicon atom content (B) of the polyvinyl alcohol that has been washed with sodium hydroxide-containing methanol and then washed through Soxhlet extraction with methanol may be the silicon atom content derived from the silyl group functionalized monomer directly incorporated into the backbone chain of the polyvinyl alcohol.

Before being analyzed to determine the silicon atom content (B), the polyvinyl alcohol is washed with sodium hydroxide-containing methanol, and the siloxane bond (—Si—O—Si—) therein is cut during the washing treatment. In this step, the silyl group functionalized monomer that is not directly incorporated into the backbone chain of the polyvinyl alcohol but is bonded to the backbone chain thereof via a siloxane bond is cut away from the polyvinyl alcohol and removed from the polymer. Therefore, it may be considered that the silicon atom content (B) of the polyvinyl alcohol may be the silicon atom content from which the silyl group functionalized monomer not directly incorporated into the backbone chain of the polymer has been removed. Accordingly, it may be considered that (A−B) in the above-mentioned relational formula 0.1/100≦(A−B)/(B)≦50/100 may indicate the silyl group content derived from the silyl group functionalized monomer units not directly incorporated into the backbone chain of the polyvinyl alcohol.

When the value (A−B)/(B) of the polyvinyl alcohol is large, it means that the polyvinyl alcohol contains a large amount of excess silyl group functionalized monomer units; and when the value (A−B)/(B) of the polyvinyl alcohol is small, it means that the amount of the excess silyl group functionalized monomer units not directly introduced into the backbone chain of the polyvinyl alcohol is small.

If the value (A−B)/(B) is too large, then a large number of siloxane bonds (—Si—O—Si—) may be formed between the excess silyl group functionalized monomer units and the silyl group functionalized monomer units incorporated into the backbone chain of the polymer. If so it may be considered that the molecular mobility of the polyvinyl alcohol may be restricted and the viscosity stability of the aqueous solution of the polyvinyl alcohol may be thereby lowered, and, in addition, the interaction between the polyvinyl alcohol and inorganic substances may increase too much and a uniform aqueous solution of a mixture of the polyvinyl alcohol and an inorganic substance may not be prepared.

If the value (A−B)/(B) is too small, then the proportion of the siloxane bonds (—Si—O—Si—) to be formed between the excess silyl group functionalized monomer units and the silyl group functionalized monomer units incorporated into the backbone chain of the polymer may be low and, as a result, the amount of the silyl groups to be in the polyvinyl alcohol will be lower and the interaction between the polyvinyl alcohol and inorganic substances will also be lower, and, in addition, when a film that contains the polyvinyl alcohol and an inorganic substance is formed, its water-resistance and binding force with the inorganic substance will be low.

The polyvinyl alcohol of the invention is preferably such that the pH of its aqueous 4% solution falls between 4 and 8. More preferably, the pH of its aqueous 4% solution falls between 4.5 and 7, even more preferably between 5 and 6.5. If the pH of the aqueous 4% solution of the polymer is lower than 4, it is unfavorable since the viscosity stability of, the aqueous polyvinyl alcohol solution may lower; and if the pH of the aqueous 4% solution of the polymer is higher than 8, it is also unfavorable since the water-resistance of the film formed of the polyvinyl alcohol with an inorganic substance may be lower.

In formula (1) that represents the silyl group of the polyvinyl alcohol of the invention, R¹ is an alkyl group having from 1 to 5 carbon atoms, and R² is an alkoxyl group or an acyloxyl group, which may have an oxygen-containing substituent, and m indicates an integer of from 0 to 2.

The alkyl group having from 1 to 5 carbon atoms for R¹ includes, for example, methyl, ethyl, n-propyl, isopropyl, n-butyl, sec-butyl, tert-butyl, isobutyl, n-pentyl, tert-pentyl and isopentyl groups. The alkoxyl group for R² includes, for example, methoxy, ethoxy, propoxy, isopropoxy, butoxy, tert-butoxy, pentoxy, hexyloxy, octyloxy, lauryloxy and oleyloxy groups. The acyloxyl group for it includes, for example, acetoxy and propionyloxy groups. The alkoxyl or acyloxy group may have an oxygen-containing substituent. One example of the substituent is an alkoxyl group such as methoxy or ethoxy group.

The polyvinyl alcohol of the invention may be produced by copolymerizing a vinyl ester monomer with a monomer having the silyl group of formula (1), followed by hydrolysis of the resulting polyvinyl ester.

Alternatively, the polyvinyl alcohol of the invention may be produced by copolymerizing a vinyl ester monomer with a monomer having a silyl group of formula (1) in the presence of a thiol compound such as 2-mercaptoethanol, n-dodecylmercaptan, mercaptoacetic acid or 3-mercaptopropionic acid, followed by hydrolyzing the resulting polyvinyl ester. This method gives a polyvinyl alcohol terminated with a thiol compound-derived functional group introduced thereinto.

The vinyl ester monomer to be used in producing the polyvinyl alcohol includes, for example, vinyl formate, vinyl acetate, vinyl propionate, vinyl valerate, vinyl caprylate, vinyl laurate, vinyl stearate, vinyl benzoate, vinyl pivalate and vinyl versatate. Of these, especially preferred is vinyl acetate.

The monomer that has the silyl group of formula (1) and is radical-copolymerized with such a vinyl ester monomer includes, for example, compounds of formula (2):

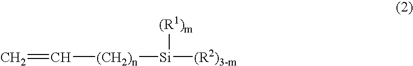

wherein R¹ represents an alkyl group having from 1 to 5 carbon atoms; R² represents an alkoxyl or acyloxyl group optionally having an oxygen-containing substituent; m indicates an integer of from 0 to 2; and n indicates an integer of from 0 to 4,

and compounds of formula (3):

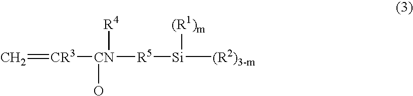

wherein R¹ represents an alkyl group having from 1 to 5 carbon atoms; R² represents an alkoxyl or acyloxyl group optionally having an oxygen-containing substituent; R³ represents a hydrogen atom or a methyl group; R⁴ represents a hydrogen atom, or an alkyl group having from 1 to 5 carbon atoms; R⁵ represents an alkylene group having from 1 to 5 carbon atoms, or a divalent hydrocarbon group that contains an oxygen or nitrogen atom; and m indicates an integer of from 0 to 2.

In formulae (2) and (3), the alkyl group having from 1 to 5 carbon atoms for R¹ includes, for example, methyl, ethyl, n-propyl, isopropyl, n-butyl, sec-butyl, tert-butyl, isobutyl, n-pentyl, tert-pentyl and isopentyl groups. The alkoxyl group for R² includes, for example, methoxy, ethoxy, propoxy, isopropoxy, butoxy, tert-butoxy, pentoxy, hexyloxy, octyloxy, lauryloxy and oleyloxy groups. The acyloxyl group for it includes, for example, acetoxy and propionyloxy groups. The alkoxyl or acyloxy group may have an oxygen-containing substituent. One example of the substituent is an alkoxyl group such as methoxy or ethoxy group. The alkyl group having from 1 to 5 carbon atoms for R⁴ includes, for example, methyl, ethyl, n-propyl, isopropyl, n-butyl, sec-butyl, tert-butyl, isobutyl, n-pentyl, tert-pentyl and isopentyl groups. The alkylene group having from 1 to 5 carbon atoms for R⁵ includes, for example, methylene, ethylene, dimethylethylene, trimethylene, tetramethylene and pentamethylene groups. The divalent hydrocarbon group that contains an oxygen or nitrogen atom for it includes, for example, —CH₂CH₂NHCH₂CH₂CH₂—, —CH₂CH₂NHCH₂CH₂—, —CH₂CH₂NHCH₂—, —CH₂CH₂N(CH₃)CH₂CH₂—, —CH₂CH₂N(CH₃)CH₂—, —CH₂CH₂OCH₂CH₂CH₂—, —CH₂CH₂OCH₂CH₂—, and —CH₂CH₂OCH₂—.

The monomer of formula (2) includes, for example, vinyltrimethoxysilane, vinylmethyldimethoxysilane, vinyldimethylmethoxysilane, vinyltriethoxysilane, vinylmethyldiethoxysilane, vinyldimethylethoxysilane, allyltrimethoxysilane, allylmethyldimethoxysilane, allyldimethylmethoxysilane, allyltriethoxysilane, allylmethyldiethoxysilane, allyldimethylethoxysilane, vinyltris(β-methoxyethoxy)silane, vinylisobutyldimethoxysilane, vinylethyldimethoxysilane, vinylmethoxydibutoxysilane, vinyldimethoxybutoxysilane, vinyltributoxysilane, vinylmethoxydihexyloxysilane, vinyldimethoxyhexyloxysilane, vinyltrihexyloxysilane, vinylmethoxydioctyloxysilane, vinyldimethoxyoctyloxysilane, vinyltrioctylxoysilane, vinylmethoxydilauryloxysilane, vinyldimethoxylauryloxysilane, vinylmethoxydioleyloxysilane, and vinyldimethoxyoleyloxysilane.

When a silyl group functionalized monomer of formula (2) where n is 1 or more is copolymerized with a vinyl ester monomer, the degree of polymerization of the polyvinyl ester obtained may lower. On the other hand, when vinyltrimethoxysilane is copolymerized with a vinyl ester monomer, the degree of polymerization of the polyvinyl ester obtained does not lower. Therefore, vinyltrimethoxysilane is favorable since its industrial production is easy and it is inexpensive.

The monomer of formula (3) includes, for example, 3-(meth)acrylamido-propyltrimethoxysilane, 3-(meth)acrylamido-propyltriethoxysilane, 3-(meth)acrylamido-propyltri(β-methoxyethoxy)silane, 2-(meth)acrylamido-ethyltrimethoxysilane, 1-(meth)acrylamido-methyltrimethoxysilane, 2-(meth)acrylamido-2-methylpropyltrimethoxysilane, 2-(meth)acrylamido-isopropyltrimethoxysilane, N-(2-(meth)acrylamido-ethyl)-aminopropyltrimethoxysilane, (3-(meth)acrylamido-propyl)-oxypropyltrimethoxysilane, 3-(meth)acrylamido-propyltriacetoxysilane, 2-(meth)acrylamido-ethyltriacetoxysilane, 4-(meth)acrylamido-butyltriacetoxysilane, 3-(meth)acrylamido-propyltripropionyloxysilane, 2-(meth)acrylamido-2-methylpropyltriacetoxysilane, N-(2-(meth)acrylamido-ethyl)-aminopropyltriacetoxysilane, 3-(meth)acrylamido-propylisobutyldimethoxysilane, 2-(meth)acrylamido-ethyldimethylmethoxysilane, 3-(meth)acrylamido-propylmethyldiacetoxysilane, 2-(meth)acrylamido-2-methylpropylhydrogendimethoxysilane, 3-(N-methyl-(meth)acrylamido)-propyltrimethoxysilane, and 2-(N-ethyl-(meth)acrylamido)-ethyltriacetoxysilane.

Of those monomers, preferred are 3-(meth)acrylamido-propyltrimethoxysilane and 3-(meth)acrylamido-propyltriacetoxysilane as their industrial production is relatively easy and they are inexpensive. In addition, 2-(meth)acrylamido-2-methylpropyltrimethoxysilane and 2-(meth)acrylamido-2-methylpropyltriacetoxysilane are also preferred since their amido bond is extremely stable to acid and alkali.

For copolymerizing such a silyl group functionalized monomer with a vinyl ester monomer, any known method of, for example, bulk polymerization, solution polymerization, suspension polymerization or emulsion polymerization may be used. Of those methods, generally bulk polymerization in the presence of no solvent or solution polymerization in a solvent such as alcohol are used. Though not unconditionally defined as varying depending on the polymerization condition and others, a continuous polymerization system is the most preferred for such a bulk polymerization or solution polymerization method for producing the polyvinyl alcohol of the invention of which the weight fraction of the polymer molecules having degree of polymerization that are more than 3 times the weight-average degree of polymerization Pw of the whole polyvinyl alcohol molecules is at most 25% by weight and of which the weight fraction of the polymer molecules having degree of polymerization that are less than ½ times the weight-average degree of polymerization Pw of the whole polyvinyl alcohol molecules is preferably at most 12% by weight, from the viewpoint of lowering the proportion of the component having high degree of polymerization (hereinafter this may be abbreviated as the high-polymerization-degree component) and the component having low degree of polymerization (hereinafter this may be abbreviated as the low-polymerization-degree component) of the polyvinyl alcohol produced in the method. For the continuous polymerization system, for example, preferred is a one-tank or two-tank continuous polymerization system, and more preferred is a one-tank continuous polymerization system. On the other hand, when a batch polymerization system is employed for producing the polyvinyl alcohol of the invention, the proportion of the high-polymerization-degree component and the low-polymerization-degree component of the polyvinyl alcohol produced may vary depending on the conversion of the vinyl ester monomer used. Concretely, with the increase in the conversion of the monomer, the proportion of the high-polymerization-degree component and the low-polymerization-degree component of the polymer produced may increase. Therefore, in the batch polymerization system, it is desirable that the monomer is polymerized to a relatively low conversion. Though not unconditionally defined as varying depending on the polymerization condition and others, the preferred conversion of the vinyl ester monomer in the batch system may fall between 10 and 80%, more preferably between 15 and 50%. Alcohol may be used for the solvent in copolymerization with solution polymerization such as a lower alcohol including methyl alcohol, ethyl alcohol, propyl alcohol. Any known initiator may be used for the copolymerization, including, for example, an azo-type initiator such as 2,2′-azobisisobutyronitrile, 2,2′-azobis(2,4-dimethylvaleronitrile), 1,1′-azobis(cyclohexane-1-carbonitrile), 2,2′-azobis(N-butyl-2-methylpropionamide); and a peroxide initiator such as benzoyl peroxide, n-propyl peroxycarbonate. The temperature for the copolymerization is not specifically defined, but preferably falls between 50° C. and 180° C.

When a silyl group flinctionalized monomer is radical-copolymerized with a vinyl ester monomer to produce the polyvinyl alcohol of the invention, they may be optionally copolymerized with any other copolymerizable monomer, if desired, not interfering with the effect of the invention. The comonomer includes, for example, α-olefins such as ethylene, propylene, 1-butene, isobutene, 1-hexene; carboxylic acids and their derivatives such as fumaric acid, maleic acid, itaconic acid, maleic anhydride, itaconic anhydride; acrylic acid and its salts, acrylates such as methyl acrylate, ethyl acrylate, n-propyl acrylate, isopropyl acrylate; methacrylic acid and its salts, methacrylates such as methyl methacrylate, ethyl methacrylate, n-propyl methacrylate, isopropyl methacrylate; acrylamide and acrylamide derivatives such as N-methylacrylamide, N-ethylacrylamide; methacrylamide and methacrylamide derivatives such as N-methylmethacrylamide, N-ethylmethacrylamide; vinyl ethers such as methyl vinyl ether, ethyl vinyl ether, n-propyl vinyl ether, isopropyl vinyl ether, n-butyl vinyl ether; hydroxy group-having vinyl ethers such as ethylene glycol vinyl ether, 1,3-propanediol vinyl ether, 1,4-butanediol vinyl ether; allyl acetate; allyl ethers such as propyl allyl ether, butyl allyl ether, hexyl allyl ether; oxyalkylene group-having monomers; isopropenyl acetate; hydroxy group-having (x-olefins such as 3-buten-1-ol, 4-penten-1-ol, 5-hexen-1-ol, 7-octen-1-ol, 9-decen-1-ol, 3-methyl-3-buten-1-ol; sulfonic acid group-having monomers such as ethylenesulfonic acid, allylsulfonic acid, methallylsulfonic acid, 2-acrylamido-2-methylpropanesulfonic acid; and cationic group-having monomers such as vinyloxyethyltrimethylammonium chloride, vinyloxybutyltrimethylammonium chloride, vinyloxyethyldimethylamine, vinyloxymethyldiethylamine, N-acrylamidomethyltrimethylammonium chloride, N-acrylamidoethyltrimethylammonium chloride, N-acrylamidodimethylamine, allyltrimethylammonium chloride, methallyltrimethylammonium chloride, dimethylallylamine, allylethylamine. The amount of the monomer need that is copolymerizable with a silyl group functionalized monomer and a vinyl ester monomer may be generally at most 20 mol %, preferably at most 10 mol % of the total amount of all the monomers to be copolymerized, though varying depending on the object and the use thereof.

The polyvinyl ester obtained through copolymerization of a silyl group functionalized monomer and a vinyl ester monomer is then hydrolyzed in a solvent in a known method to be a polyvinyl alcohol.

In general, an alkaline substance is used for the catalyst for hydrolysis of the polyvinyl ester. Examples include alkali metal hydroxides such as potassium hydroxide, sodium hydroxide; and alkali metal alkoxides such as sodium methoxide. The amount of the alkaline substance to be used preferably falls between 0.004 and 0.5, more preferably between 0.005 and 0.05 in terms of the molar ratio thereof to the vinyl ester monomer units in the polyvinyl ester to be produced. The catalyst for hydrolysis may be added to the reaction system all at a time in the initial stage of hydrolysis, or may be intermittently added thereto in such a manner that a part thereof is added in the initial stage of hydrolysis and the remaining part thereof is during hydrolysis.

The solvent used in hydrolysis includes, for example, methanol, methyl acetate, dimethylsulfoxide, diethylsulfoxide, dimethylformamide. Of those solvents, preferred is methanol. The water content of the methanol is preferably between 0.001 and 1% by weight, more preferably between 0.003 and 0.9% by weight, even more preferably between 0.005 and 0.8% by weight.

The hydrolysis may be effected preferably at a temperature of 5 to 80° C., more preferably at 20 to 70° C. The time for hydrolysis is preferably 5 minutes to 10 hours, more preferably 10 minutes to 5 hours. The hydrolysis may be effected either batchwise or continuously. After the hydrolysis, if desired, the remaining catalyst may be neutralized. The neutralizing agent usable for it includes, for example, organic acids such as acetic acid, lactic acid; and ester compounds such as methyl acetate.

The degree of hydrolysis of the polyvinyl alcohol of the invention is not specifically defined but is preferably at least 80 mol %, more preferably at least 85 mol %, even more preferably at least 90 mol %. When a film of the polyvinyl alcohol with an inorganic substance is formed, its water-resistance is preferably higher. For it, the optimum degree of hydrolysis of the polyvinyl alcohol is at least 95 mol %.

The polyvinyl alcohol thus obtained through hydrolysis may be washed, if desired. This operation is useful as a means for controlling the value (A−B)/(B) of the polyvinyl alcohol mentioned hereinabove.

The washing liquid used for the purpose includes, for example, lower alcohols such as methanol, lower fatty acid esters such as methyl acetate, and their mixtures. The washing liquid may contain a small amount of water, alkali or acid added thereto.

The washing method for the polyvinyl alcohol varies depending on the conversion in copolymerizing a vinyl ester monomer and a silyl group functionalized monomer, the degree of polymerization of the polyvinyl ester obtained through the copolymerization, and the degree of hydrolysis of the polyvinyl alcohol obtained through hydrolysis of the polyvinyl ester. For example, in one method, a lower alcohol such as methanol, a lower fatty acid ester such as methyl acetate or a mixture thereof is used for the washing liquid and in an amount of from 1 to 20 times the weight of the wet polyvinyl alcohol that is obtained through hydrolysis of the copolymer of a vinyl ester monomer with a silyl group functionalized monomer (polyvinyl ester) in an alcohol solution and is not as yet dried, therefore containing alcohol and others, and the polyvinyl alcohol in that condition is washed with the washing liquid at a temperature falling between 20° C. and the boiling point of the washing liquid for 30 minutes to 10 hour or so.

The polyvinyl alcohol of the invention may be stored and transported while it is powdery. In its use, it may be still powdery or may be dispersed in liquid. The polyvinyl alcohol may be dissolved in water as an aqueous solution. In this case, the polyvinyl alcohol is once dispersed in water and then heated with stirring to give a uniform aqueous solution thereof. In this case, the polyvinyl alcohol may form a uniform aqueous solution even though an alkali such as sodium hydroxide is not specifically added to water.

The polyvinyl alcohol of the invention may be readily dissolved in water to form an aqueous solution even though an alkali such as sodium hydroxide or an acid is not added thereto; the aqueous solution have good viscosity stability; films formed of or derived from the aqueous solution have excellent water resistance; the binding force with inorganic substances is high; and films formed of mixtures of the polyvinyl alcohol with an inorganic substance have excellent water resistance. Having these advantages, the polymer may be used for coating agents. Coated objects fabricated by applying a coating agent that contains the polyvinyl alcohol of the invention onto a substrate is favorably used for inkjet recording materials and thermal recording materials.

In the case where a coating agent that contains the polyvinyl alcohol of the invention is applied onto a substrate to fabricate an inkjet recording material, the polyvinyl alcohol favorably acts as the binder in the ink-receiving layer of the material. In this case, the polyvinyl alcohol of the invention may be used alone or may be combined with any other water-soluble or water-dispersible resin. The water-soluble resin that may be combined with the polyvinyl alcohol of the invention includes, for example, albumin, gelatin, casein, starch, cationated starch, gum arabic, polyamide resins, melamine resins, poly(meth)acrylamide, polyvinylpyrrolidone, sodium poly(meth)acrylate, anion-modified PVA, sodium alginate, water-soluble polyesters, cellulose derivatives such as methyl cellulose, hydroxyethyl cellulose and carboxymethyl cellulose (CMC); and the water-dispersible resins that may be combined with the polyvinyl alcohol of the invention includes, for example, SBR latex, NBR latex, polyvinyl acetate emulsion, ethylene/vinyl acetate copolymer emulsion, poly(meth)acrylate emulsion, polyvinyl chloride emulsion; but these are not limitative.

In the case where the polyvinyl alcohol of the invention is used for the binder in the ink-receiving layer of an inkjet recording material, the filler that may be present in the ink-receiving layer includes, for example, precipitated silica, silica gel, fumed silica, colloidal silica, colloidal alumina, aluminum hydroxide, pseudoboehmite, clay, talc, diatomaceous earth, zeolite, calcium carbonate, alumina, zinc oxide, satin white, organic pigment, but these are not limiting. The ratio of the polyvinyl alcohol to the filler is not limiting, and usually, the polyvinyl alcohol/filler ratio preferably falls between 5/100 and 100/100 by weight, more preferably between 10/100 and 80/100 by weight, even more preferably between 15/100 and 60/100.

When the polyvinyl alcohol of the invention is used for the binder in the ink-receiving layer of an inkjet recording material, it may be combined with a cationic resin serving as an ink fixer. The cationic resin may be a monomer, oligomer or polymer, preferably an oligomer or polymer having a primary to tertiary amine or a quaternary ammonium salt that may be dissociated to be cationic when dissolved in water. Concretely, for example, it includes dimethylamine-epichlorohydrin polycondensate, acrylamide-diallylamine copolymer, polyvinylamine copolymer, dimethyldiallylammonium chloride polymer, polyethylenimine, but these are not limitative.

For the substrate for the inkjet recording material, usable is any known transparent or non-transparent support substrate. The transparent support substrate may be a film or sheet of, for example, polyester, polystyrene, polyvinyl chloride, polymethyl methacrylate, cellulose acetate, polycarbonate, polyimide, cellophane or celluloid, or paper of high transparency. The non-transparent support substrate may be ordinary paper, pigment-coated paper, cloth, wood, metal plate, synthetic paper, as well as synthetic resin film or sheet that has been processed for non-transparency.

A coating agent that contains the polyvinyl alcohol of the invention may be applied onto a substrate to fabricate an inkjet recording material, for example, by a method that comprises dissolving or dispersing the polyvinyl alcohol and optionally a filler, an ink fixer and others in an aqueous medium to prepare a coating agent, and applying the thus-prepared coating agent onto a substrate by the use of any known size press, air knife coater, roll coater, bar coater, blade coater, curtain coater, cast coater or the like. For the aqueous medium, preferred is water. For the aqueous solvent, also usable is an aqueous solution prepared by dissolving any of water-soluble organic solvents, acids, bases or salts in water. The coating agent that contains the polyvinyl alcohol of the invention is applied onto a substrate to fabricate an inkjet recording material. The coating agent that contains the polyvinyl alcohol is applied onto a substrate to impregnate the coating agent therein, or to form a PVA-coating layer on one or both surfaces thereof. Thus fabricated, the water-resistance of the inkjet recording material and the binding force of PVA with an inorganic substance therein are good.

In the case where a coating agent that contains the polyvinyl alcohol of the invention is applied onto a substrate to fabricate a thermal recording material, the polyvinyl alcohol of the invention may be in any of the overcoat layer, the thermo-sensitive coloring layer or the undercoat layer of the material. In particular, the polyvinyl alcohol of the invention is preferred for the binder in the overcoat layer and the thermo-sensitive coloring layer of the material.

The thermal recording material in which the polyvinyl alcohol of the invention is in the overcoat layer has good water-resistance and good plasticizer resistance. When the polyvinyl alcohol of the invention is in the overcoat layer of a thermal recording material, it is generally combined with a crosslinking agent. The crosslinking agent is preferably an aldehyde compounds such as glyoxal, glutaraldehyde; zirconium compounds such as ammonium zirconium carbonate; titanium compounds such as titanium lactate; colloidal silica; epoxy compounds such as polyamidamine-epichlorohydrin; and polyoxazoline. Not interfering with the water-resistance and the plasticizer resistance thereof, the polyvinyl alcohol of the invention may be combined with any known polymer or a dispersion thereof such as those mentioned below. Specific examples of the polymer and its dispersion are starch and its derivatives; cellulose derivatives such as hydroxymethyl cellulose, hydroxyethyl cellulose, carboxymethyl cellulose, methyl cellulose, ethyl cellulose; other water-soluble polymers such as polyvinyl alcohol, sodium polyacrylate, polyvinylpyrrolidone, acrylamide/acrylate copolymer, acrylamide/acrylate/methacrylic acid terpolymer, alkali salt of styrene/maleic anhydride copolymer, alkali salt of isobutylene/maleic anhydride copolymer, polyacrylamide, sodium alginate, gelatin, casein; emulsions of polyvinyl acetate, polyurethane, polyacrylic acid, polyacrylate, vinyl chloride/vinyl acetate copolymer, polybutyl methacrylate, ethylene/vinyl acetate copolymer; and latexes of styrene/butadiene copolymer, styrene/butadiene/acrylic copolymer.

When the polyvinyl alcohol of the invention is in the overcoat layer of a thermal recording material, the filler that may be combined with the polyvinyl alcohol may be any of kaolin, clay, talc, calcium carbonate, calcined clay, titanium oxide, diatomaceous earth, precipitated silica, silica gel, colloidal silica, aluminum oxide, aluminum hydroxide, synthetic aluminum silicate, synthetic magnesium silicate, polystyrene particles, polyvinyl acetate particles, urea-formalin resin particles. In the overcoat layer, the amount of the filler is preferably at least 20% by weight of the total amount of all the components of the overcoat layer. If the amount is smaller than 20% by weight, the water-resistance, the oil resistance and the plasticizer resistance of the layer may be poor.

The amount of the overcoat layer to be formed in fabricating a thermal recording material may be suitably selected within a range which the thermal conduction from the thermal head of a thermal recording apparatus to the thermo-sensitive coloring layer of the thermal recording material is not retarded, and is generally from 1 to 10 g/m², preferably from 2 to 7g/m².

The thermal recording material that contains the polyvinyl alcohol of the invention in its thermo-sensitive coloring layer may have good water-resistance and good plasticizer resistance. Although not specifically defined, the thermo-sensitive dye to be in the thermo-sensitive coloring layer may be any and every one that is generally in ordinary pressure-sensitive recording materials or thermal recording materials. Specific examples of the thermo-sensitive dye are triarylmethane compounds such as 3,3-bis(p-dimethylaminophenyl)-6-dimethylaminophthalide (crystal violet lactone), 3-(p-dimethylaminophenyl)-3-(1,2-dimethylindol-3-yl)phthalide, 3-(p-dimethylaminophenyl)-3-(2-phenylindol-3-yl)phthalide, 3,3-bis(9-ethylcarbazol-3-yl)-5-dimethylaminophthalide; diphenylmethane compounds such as 4,4′-bisdimethylaminobenzhydrin benzyl ether, N-halophenyl-leucoauramine; xanthene compounds such as rhodamine B-anilinolactam, 3-diethylamino-7-benzylaminofluoran, 3-diethylamino-7-butylaminofluoran, 3-diethylamino-7-(chloroanilino)fluoran, 3-diethylamino-6-methyl-7-anilinofluoran, 3-piperidino-6-methyl-7-anilinofluoran, 3-ethyltolylamino-6-methyl-7-anilinofluoran, 3-cyclohexylmethylamino-6-methyl-7-anilinofluoran, 3-diethylamino-6-chloro-7-(β-ethoxyethyl)aminofluoran, 3-diethylamino-6-chloro-7-(γ-chloropropyl)aminofluoran, 3-(N-ethyl-N-isoamyl)-6-methyl-7-phenylaminofluoran, 3-dibutylamino-6-methyl-7-anilinofluoran; thiazine compounds such as benzoyl-leucomethylene blue, p-nitrobenzoyl-leucomethylene blue; and spiro compounds such as 3-methyl-spiro-dinaphthopyran, 3-ethyl-spiro-dinaphthopyran, 3-benzylspiro-dinaphthopyran, 3-methylnaphtho-(3-methoxy-benzo)-spiropyran. These thermo-sensitive dyes are suitably selected in accordance with the use of the thermal recording material to be fabricated, and one or more of them are used either singly or as a mixture of two or more of them.

For the developer that may be in the thermo-sensitive coloring layer, preferred are phenol derivatives and aromatic carboxylic acid derivatives, and more preferred are bisphenols. Specific examples of the phenol derivatives are p-octylphenol, p-tert-butylphenol, p-phenylphenol, 1,1-bis(p-hydroxyphenyl)propane, 2,2-bis(p-hydroxyphenyl)propane, 1,1-bis(p-hydroxyphenyl)pentane, 1,1-bis(p-hydroxyphenyl)hexane, 2,2-bis(p-hydroxyphenyl)hexane, 1,1-bis(p-hydroxyphenyl)-2-ethylhexane, 2,2-bis(4-hydroxy-3,5-dichlorophenyl)propane, dihydroxydiphenyl ether. Specific examples of the aromatic carboxylic acid derivatives are p-hydroxybenzoic acid, ethyl p-hydroxybenzoate, butyl p-hydroxybenzoate, 3,5-di-tert-butylsalicylic acid, 3,5-di-α-methylbenzylsalicylic acid, and polyvalent metal salts of these carboxylic acids.

When the polyvinyl alcohol of the invention is used in the thermo-sensitive coloring layer of a thermal recording material, it may be combined with any known polymer or a dispersion thereof such as those mentioned below, not interfering with the water-resistance and the plasticizer resistance thereof. Specific examples of the polymer and its dispersion are starch and its derivatives; cellulose derivatives such as hydroxymethyl cellulose, hydroxyethyl cellulose, carboxymethyl cellulose, methyl cellulose, ethyl cellulose; other water-soluble polymers such as gum arabic, polyvinyl alcohol, alkali salt of acrylate (or methacrylate) copolymer, polyvinylpyrrolidone, acrylamide (or methacrylamide)/acrylate (or methacrylate) copolymer, alkali salt of styrene/maleic anhydride copolymer, alkali salt of isobutylene/maleic anhydride copolymer, alkali salt of diisobutylene/maleic anhydride copolymer, polyacrylamide, sodium alginate, gelatin, casein; emulsions of polyvinyl acetate, polyurethane, polyacrylic acid, polyacrylate, vinyl chloride/vinyl acetate copolymer, polybutyl methacrylate, ethylene/vinyl acetate copolymer; and latexes of styrene/butadiene copolymer, styrene/butadiene/acrylic copolymer.

A lubricant may be in the thermo-sensitive coloring layer, which includes, for example, higher fatty acids, higher fatty acid amides, metal salts of higher fatty acids, paraffin wax, microcrystalline wax.

The filler that may be in the thermo-sensitive coloring layer includes, for example, kaolin, clay, talc, calcium carbonate, calcined clay, titanium oxide, diatomaceous earth, precipitated silica, silica gel, colloidal silica, aluminum oxide, aluminum hydroxide, synthetic aluminum silicate, synthetic magnesium silicate, polystyrene particles, polyvinyl acetate particles, urea-formalin resin particles. The amount of the filler to be in the thermo-sensitive coloring layer is preferably at least 20% by weight of the total amount of all the components of the layer.

In the case where a coating agent that contains the polyvinyl alcohol of the invention is applied onto a substrate to fabricate a thermal recording material, employable is any known method of air knife coating, blade coating, gravure coating, roll coating, spraying, dipping, bar coating or extrusion coating.

Apart from the above, the polyvinyl alcohol of the invention may be used for other various applications, based on the function of the functional groups in the polymer, such as a hydroxyl group, a vinyl ester group and a silyl group. Examples of the applications are internal sizing agents for paper, fiber processing agents, dyes, coating agents for glass fibers, surface coating agents for metals, other coating agents such as antifogging agent, adhesives for wood, paper, aluminum foil and plastics, binders for nonwoven fabrics, binders for fibers, binders for construction materials such as gypsum boards and fiber plates, thickeners for various emulsion adhesives, additives to urea resin adhesives, additives to cement and mortar, various adhesives such as hot-melt adhesives and pressure-sensitive adhesives, dispersants for emulsion polymerization of various ethylenic unsaturated monomers such as ethylene, vinyl acetate and vinyl chloride, stabilizers for pigment dispersion in paints and adhesives, dispersion stabilizers for suspension polymerization of various ethylenic unsaturated monomers such as vinyl chloride, vinylidene chloride, styrene, (meth)acrylic acid and vinyl acetate, shaped articles such as fibers, films, sheets, pipes, tubes, water-soluble fibers and temporary films, hydrophilicating agents for hydrophobic resins, additives to synthetic resins such as those to bicomponent fibers, films and other shaped articles, soil improvers, and soil stabilizers.

Polyvinyl acetal that is obtained through acetalization of the polyvinyl alcohol of the invention with an aldehyde compound such as acetaldehyde or butyraldehyde is useful, for example, for interlayers for safety glass, ceramic binders, ink dispersants and photosensitive materials.

### EXAMPLES

The invention is described in more detail with reference to the following Examples and Comparative Examples which are not intended to further limit the invention. Unless otherwise specifically indicated, “part” and “%” in the following Examples and Comparative Examples are all by weight.

1. Silyl Group Functionalized Polyvinyl Alcohol

PVA was produced according to the method mentioned below, and the degree of hydrolysis thereof, the silyl group functionalized monomer unit content thereof, the weight-average degree of polymerization thereof and the silicon atom content thereof were measured.

Degree of Hydrolysis of PVA:

The degree of hydrolysis of PVA is determined according to the method described in JIS-K6726 incorporated herein by reference.

Silyl group functionalized Monomer Unit Content of PVA:

Before hydrolyzed, a polyvinyl ester is purified through reprecipitation with hexane-acetone so that the non-reacted silyl group functionalized monomer is completely removed from the polymer. Next, the thus-processed polymer is dried under reduced pressure at 90° C. for 2 days, and then dissolved in CDCl₃ to prepare a sample to be analyzed. The sample is analyzed by the use of a 500 MHz proton-NMR device (JEOL GX-500), and the silyl group functionalized monomer unit content of PVA is thus determined. Weight-Average Degree of Polymerization of PVA:

PVA is hydrolyzed to a degree of hydrolysis of 99.5 mol % or more to prepare a sample, and this is analyzed through LALLS (low-angle laser light scattering spectrometry) to obtain the weight-average molecular weight of PVA. In a GPC 224-type gel permeation chromatography device (by Waters) with three columns TSK-gel-GMPWxL (by Tosoh) connected in series therein, the sample is analyzed at 23° C. The solvent is 0.08 M tris-buffer (pH 7.9); and the detector is a differential refractiometer R-401 Model, 8X (by Waters). For obtaining the absolute molecular weight of the sample, a low-angle laser light scattering spectrometer KMX-6 Model (by Chromatix) is connected to the chromatography device. The weight-average molecular weight of the sample thus measured is divided by the formular weight of the vinyl alcohol monomer unit, 44 to obtain the weight-average degree of polymerization of the polymer sample. The weight fraction of the polymer molecules of which the degree of polymerization are more than 3 times the weight-average degree of polymerization of the whole PVA molecules, and the weight fraction of the polymer molecules of which the degree of polymerization are less than ½ times the weight-average degree of polymerization of the whole PVA molecules are obtained on the integral distribution of polymerization degree, which is calculated from the data obtained through the measurement as above.

Silicon Atom Content of PVA:

The silicon atom content of PVA is determined by the use a Jares Ash's ICP spectrophotometer IRIS AP, according to the method mentioned above.

PVA1:

2500 parts of vinyl acetate, 1656 parts of methanol and 752 parts of methanol solution containing 2% by weight of vinyltrimethoxysilane (VMS) were fed into a polymerization reactor equipped with a stirrer, a temperature sensor, a chemical inlet line, a polymer liquid outlet line and a reflux condenser, purged with nitrogen with stirring, and then heated up to 60° C. To this was added 20 parts of methanol containing 0.1 parts of 2,2′-azobis(4-methoxy-2,4-dimethoxyvaleronitrile) (AMV), and the polymerization was initiated with it. From the start of the polymerization, 100 parts of methanol solution containing 2% by weight of VMS was added and the polymerization was continued. In addition, methanol solution containing 0.13% by weight of AMV was added to the system at a rate of 23 parts/hr, and the polymerization was continued for 4 hours until the solid concentration in the system reached 25%. After the solid concentration in the system reached 25%, 625 parts/hr of vinyl acetate, 4-14 parts/hr of methanol, 188 parts/hr of 2% VMS-containing methanol solution and 23 parts/hr of 0.13% AMV-containing methanol solution were added to the system, while the polymer liquid was continuously taken out of the system so that the liquid level in the polymerization reactor could be kept constant. In that manner, the polymerization was continued. Four hours after the start of the addition of the solution, the polymer liquid was recovered. Methanol vapor was introduced into the thus-recovered polymer liquid so that the non-reacted vinyl acetate monomer was expelled out. This gave 40% polyvinyl ester-containing methanol solution. At the start of the polymer liquid recovery, the solid concentration in the system was 25%.

To the 40% polyvinyl ester-containing methanol solution, added were methanol and methanol solution containing 10% by weight of sodium hydroxide in that order with stirring so that the molar ratio of sodium hydroxide to the vinyl acetate units in the polyvinyl ester could be 0.02 and the solid concentration of the polyvinyl ester could be 35% by weight. In that condition, hydrolysis of the polyvinyl ester was started at 40° C.

With the progress of the hydrolysis, a gel was formed and it was taken out of the reaction system immediately after its formation. Then, this was ground, and 1 hour after the start of the hydrolysis, this was neutralized with methyl acetate added thereto to obtain PVA swollen with methanol. To this, added was methanol of 6 times the weight of the methanol-swollen PVA (bath ratio, 6 times), and this was washed under reflux for 1 hour and then dried at 65° C. for 16 hours to obtain PVA.

The vinyltrimethylsilane unit content of the thus-obtained PVA was 0.50 mol %, the degree of hydrolysis thereof was 98.5 mol %, and the weight-average degree of polymerization thereof was 580. The value (A−B)/(B) obtained according to the method of determining the silicon atom content of PVA mentioned above was 10.9/100, and the pH of the aqueous 4% PVA solution was 6.0.

PVA2:

PVA2 was produced in the same manner as that for PVA1 except that the amount of vinyl acetate and methanol to be fed, the amount of the silyl group functionalized monomer to be fed, the amount of the polymerization initiator to be used and the polymerization condition were varied as in Table 1. The analytic data of the thus-obtained PVA are shown in Table 4.

PVA3:

2000 parts of vinyl acetate, 2352 parts of methanol and 600 parts of methanol solution containing 2% by weight of vinyltrimethoxysilane (VMS) were fed into a polymerization reactor 1 equipped with a stirrer, a temperature sensor, a chemical inlet line, a polymer liquid outlet line and a reflux condenser, and into a polymerization reactor 2 equipped with the same units, and these were purged with nitrogen with stirring and then heated up to 60° C. To the polymerization reactor 1 and the polymerization reactor 2, added was 20 parts of methanol containing 0.05 part of 2,2′-azobis(4-methoxy-2,4-dimethoxyvaleronitrile) (AMV), and the polymerization was initiated with it. From the start of the polymerization, 80 parts of methanol solution containing 2% by weight of VMS was added to each polymerization reactor at a rate of 150 parts/hr, and the polymerization was continued. In addition, methanol solution containing 0.13% by weight of AMV was added to the polymerization reactor 1 and the polymerization reactor 2 at a rate of 4 parts/hr, and the polymerization was continued for 4 hours until the solid concentration in the system reached 10%. Next, 500 parts/hr of vinyl acetate, 588 parts/hr of methanol, 150 parts/hr of 2% VMS-containing methanol solution and 4 parts/hr of 0.13% AMV-containing methanol solution were added to the polymerization reactor 1, while the polymer liquid was continuously carried over from the polymerization reactor 1 to the polymerization reactor 2 and the polymer liquid was continuously removed out from the polymerization reactor 2, so that the liquid level both in the polymerization reactor 1 and the polymerization reactor 2 could be kept constant. In that manner, the polymerization was continued. When the polymer liquid was carried over from the polymerization reactor 1 to the polymerization reactor 2, 8 parts/hr of 0.13% AMV-containing methanol was added thereto.

Four hours after the start of the transfer of the polymer liquid and when the solid. concentration in the polymerization reactor 1 reached 10% and that in the polymerization reactor 2 reached 24%, the polymer liquid was recovered from the polymerization reactor 2. Methanol vapor was introduced into the thus-recovered polymer liquid so that the non-reacted vinyl acetate monomer was expelled out. This gave 40% polyvinyl ester-containing methanol solution.

To the 40% polyvinyl ester-containing methanol solution, added were methanol and methanol solution containing 10% by weight of sodium hydroxide in that order with stirring so that the molar ratio of sodium hydroxide to the vinyl acetate units in the polyvinyl ester could be 0.02 and the solid concentration of the polyvinyl ester could be 35% by weight. In that condition, hydrolysis of the polyvinyl ester was started at 40° C.

With the progress of the hydrolysis, a gel was formed and it was taken out of the reaction system immediately after its formation. Then, this was ground, and 1 hour after the start of the hydrolysis, this was neutralized with methyl acetate added thereto to obtain PVA swollen with methanol. To this, added was methanol of 6 times the weight of the methanol-swollen PVA (bath ratio, 6 times), and this was washed under reflux for 1 hour and then dried at 65° C. for 16 hours to obtain PVA.

The vinyltrimethylsilane content of the thus-obtained PVA was 0.50 mol %, the degree of hydrolysis thereof was 98.2 mol %, and the weight-average degree of polymerization thereof was 590. The value (A−B)/(B) obtained according to the method of determining the silicon atom content of PVA mentioned above was 9.6/100, and the pH of the aqueous 4% PVA solution was 6.0.

PVA4:

PVA4 was produced in the same manner as that for PVA3 except that the amount of vinyl acetate and methanol to be fed, the amount of the silyl group functionalized monomer to be fed, the amount of the polymerization initiator to be used, the polymerization condition and the hydrolysis condition were varied as in Table 2. The analytic data of the thus-obtained PVA are shown in Table 4.

PVA5:

1050 parts of vinyl acetate, 2056 parts of methanol and 394 parts of methanol solution containing 2% by weight of vinyltrimethoxysilane were fed into a 6-liter separable flask equipped with a stirrer, a temperature sensor, a dropping funnel and a reflux condenser, purged with nitrogen with stirring, and then heated up to 60° C. To this was added 20 parts of methanol containing 1.3 parts of 2,2′-azobisisobutyronitrile, and the polymerization was initiated with it. From the start of the polymerization, 30 parts of methanol solution containing 2% by weight of vinyltrimethoxysilane was added to the system and the polymerization was continued for 4 hours. In that stage, the polymerization was stopped. At the time at which the polymerization was stopped, the solid concentration in the system was 15.2%. Next, methanol vapor was introduced into the system so as to expel the non-reacted vinyl acetate monomer from the system. This gave 40% polyvinyl ester-containing methanol solution.

To the 40% polyvinyl ester-containing methanol solution, added were methanol and methanol solution containing 10% by weight of sodium hydroxide in that order with stirring so that the molar ratio of sodium hydroxide to the vinyl acetate units in the polyvinyl ester could be 0.02 and the solid concentration of the polyvinyl ester could be 35% by weight. In that condition, hydrolysis of the polyvinyl ester was started at 40° C.

With the progress of the hydrolysis, a gel was formed and it was taken out of the reaction system immediately after its formation. Then, this was ground, and 1 hour after the start of the hydrolysis, this was neutralized with methyl acetate added thereto to obtain PVA swollen with methanol. To this, added was methanol of 6 times the weight of the methanol-swollen PVA (bath ratio, 6 times), and this was washed under reflux for 1 hour and then dried at 65° C. for 16 hours to obtain PVA.

The vinyltrimethylsilane content of the thus-obtained PVA was 0.50 mol %, the degree of hydrolysis thereof was 98.5 mol %, and the weight-average degree of polymerization thereof was 560. The value (A−B)/(B) obtained according to the method of determining the silicon atom content of PVA mentioned above was 10.9/100, and the pH of the aqueous 4% PVA solution was 6.0.

PVA6 to PVA9:

Various PVAs (PVA6 to PVA9) were produced in the same manner as that for PVA5 except that the amount of vinyl acetate and methanol to be fed, the type and the amount of the silyl group functionalized monomer to be fed, the amount of the polymerization initiator to be used, the polymerization condition and the hydrolysis condition were varied as in Table 3. The analytic data of the thus-obtained PVAs are shown in Table 4.

PVA10:

PVA10 was produced in the same manner as that for PVA1, for which, however, the polyvinyl ester hydrolysis was effected by addition of methanol solution containing 10% by weight of sodium hydroxide in such a manner that the molar ratio of sodium hydroxide to the vinyl acetate units in the polyvinyl ester could be 0.01. The analytic data of the thus-obtained PVA are shown in Table 4.

PVA11:

PVA11 was produced in the same manner as that for PVA2, for which, however, the polyvinyl ester hydrolysis was effected by addition of methanol solution containing 10% by weight of sodium hydroxide in such a manner that the molar ratio of sodium hydroxide to the vinyl acetate units in the polyvinyl ester could be 0.01. The analytic data of the thus-obtained PVA are shown in Table 4.

PVA12:

PVA12 was produced in the same manner as that for PVA2, for which, however, the washing operation with methanol was omitted. The analytic data of the thus-obtained PVA are shown in Table 4.

PVA13:

PVA13 was produced in the same manner as that for PVA2, for which, however, PVA obtained through hydrolysis was washed through Soxhlet extraction with methanol before it was neutralized with methyl acetate. The analytic data of the thus-obtained PVA are shown in Table 4.

PVA14:

PVA14 was produced in the same manner as that for PVA2, for which, however, PVA obtained through hydrolysis was neutralized with acetic acid in place of methyl acetate, the amount of acetic acid used for neutralization was 5 molar times that of sodium hydroxide used for hydrolysis, and the washing operation with methanol (bath ratio, 6 times) was effected at room temperature for 1 hour. The analytic data of the thus-obtained PVA are shown in Table 4.

PVA15:

PVA15 was produced in the same manner as that for PVA2, for which, however, the neutralization with methyl acetate was omitted, and the washing operation (bath ratio, 6 times) with methanol was effected at room temperature for 1 hour. The analytic data of the thus-obtained PVA are shown in Table 4.

PVA16 and PVA17:

PVA16 and PVA17 were produced in the same manner as that for PVA1 except that the amount of vinyl acetate and methanol to be fed, the amount of the silyl group functionalized monomer to be fed, the amount of the polymerization initiator to be used and the polymerization condition were varied as in Table 1. The analytic data of the thus-obtained PVAs are shown in Table 4.

PVA18 and PVA19:

PVA18 and PVA19 were produced in the same manner as that for PVA3 except that the amount of vinyl acetate and methanol to be fed, the amount of the silyl group functionalized monomer to be fed, the amount of the polymerization initiator to be used, the polymerization condition and the hydrolysis condition were varied as in Table 2. The analytic data of the thus-obtained PVAs are shown in Table 4.

PVA20 and PVA21:

PVA20 and PVA21 were produced in the same manner as that for PVA5 except that the amount of vinyl acetate and methanol to be fed, the type and the amount of the silyl group functionalized monomer to be fed, the amount of the polymerization initiator to be used, the polymerization condition and the hydrolysis condition were varied as in Table 3. The analytic data of the thus-obtained PVAs are shown in Table 4.

PVA22:

PVA22 was produced in the same manner as that for PVA16, for which, however, the polyvinyl ester hydrolysis was effected by addition of methanol solution containing 10% by weight of sodium hydroxide in such a manner that the molar ratio of sodium hydroxide to the vinyl acetate units in the polyvinyl ester could be 0.01. The analytic data of the thus-obtained PVA are shown in Table 4.

PVA23:

PVA23 was produced in the same manner as that for PVA17, for which, however, the polyvinyl ester hydrolysis was effected by addition of methanol solution containing 10% by weight of sodium hydroxide in such a manner that the molar ratio of sodium hydroxide to the vinyl acetate units in the polyvinyl ester could be 0.01. The analytic data of the thus-obtained PVA are shown in Table 4.

### Example 1 to Example 15

PVA1 to PVA15 were tested for the viscosity stability of the aqueous solution of PVA, the water-resistance of the PVA film, the water-resistance of the PVA film with an inorganic substance, and the binding force of PVA with inorganic substances, according to the test methods mentioned below. The results are shown in Table 5.

### Comparative Example 1 to Comparative Example 8

PVA16 to PVA23 were tested for the viscosity stability of the aqueous solution of PVA, the water-resistance of the PVA film, the water-resistance of the PVA film with an inorganic substance, and the binding force of PVA to inorganic substances, according to the test methods mentioned below. The results are shown in Table 5.

Viscosity Stability of Aqueous PVA Solution:

An aqueous solution of 9% PVA is prepared and left in a thermostat at 10° C. Immediately after the temperature of the aqueous PVA solution has reached 10° C. and after 7 days, the viscosity of the solution is measured. The viscosity of the aqueous PVA solution after 7 days is divided by the viscosity thereof immediately after its temperature has reached 10° C. (after 7 days/immediately after the temperature control). From the data, the PVA tested is evaluated according to the criteria mentioned below.

A: Less than 2.5 times.

B: From 2.5 times to less than 3.5 times.

C: 3.5 times or more, but PVA did not gel.

D: PVA lost fluidity and gelled.

Water-Resistance of PVA Film:

An aqueous 4% PVA solution is prepared, and this is cast at 20° C. to form a film having a thickness of 40 μm. The film is heated at 120° C. for 10 minutes, and then cut to give a test piece having a length of 10 cm and a width of 10 cm. The test piece is dipped in distilled water at 20° C. for 30 minutes, and then taken out (recovered), water having adhered to its surface is wiped away with cotton gauze, and its wet weight is measured. After thus measured, the wet test piece is dried at 105° C. for 16 hours, and its dry weight is measured. The wet weight of the test piece is divided by the dry weight thereof, and this is a degree of swelling (times). From it, the PVA tested is evaluated according to the criteria mentioned below.

A: Less than 4.0 times.

B: From 4.0 times to less than 5.0 times.

C: From 5.0 times to less than 9.0 times.

D: 9.0 times or more, or the dipped test piece could not be recovered.

Water-Resistance of PVA Film with Inorganic Substance:

An aqueous 4% PVA solution is prepared, to which is added an aqueous dispersion of 20% colloidal silica (Nissan Chemical Industry's Snowtex ST-O) in such a manner that the solid content-based ratio by weight of PVA/colloidal silica may be 100/10, and the resulting mixture is cast at 20° C. to form a film having a thickness of 40 μm.

The film is heated at 120° C. for 30 minutes, and then cut to give a test piece having a length of 10 cm and a width of 10 cm. The test piece is dipped in distilled water at 20° C. for 24 hours, and then taken out (recovered), water having adhered to its surface is wiped away with cotton gauze, and its wet weight is measured. After thus measured, the wet test piece is dried at 105° C. for 16 hours, and its dry weight is measured. The wet weight of the test piece is divided by the dry weight thereof, and this is a degree of swelling (times). From it, the PVA tested is evaluated according to the criteria mentioned below.

A: Less than 5.0 times.

B: From 5.0 times to less than 8.0 times.

C: From 8.0 times to less than 12.0 times.

D: 12.0 times or more, or the dipped test piece could not be recovered.

Evaluation of Binding Force of PVA with Inorganic Substance:

Silica (Mizusawa Chemical Industry's Mizukasil P78D) and 0.2%, based on the weight of silica, of a dispersant (Toa Synthetic Chemical Industry's Aron T40) are dispersed in water by the use of a homogenizer to prepare an aqueous dispersion of 20% silica. To the aqueous silica dispersion, added is an aqueous 10% PVA solution in such a manner that the solid content-based ratio by weight of silica/PVA may be 100/35, and a necessary amount of water is added thereto to prepare a silica-dispersed PVA solution having a concentration of 15%.

The silica-dispersed PVA solution thus obtained is applied onto the surface of woodfree paper, using a wire bar. Its amount applied to the paper is 60 g/m² in a basic weight. Thus coated, the paper is dried with a hot air drier at 100° C. for 3 minutes. This is a coated test sample. After dried, the amount of the coating layer on the paper (test sample) is 11 g/m².

Using an IGT printability tester, the sample is tested under a printing pressure of 25 kg/cm². The printing speed (cm/sec) at which the surface of the test sample has peeled is read, and this indicates the surface strength of the test sample. From it, the binding force of PVA tested herein is evaluated according to the criteria mentioned below. In testing the sample with the IGT printability tester, used is IGT Pick Oil M (by Dai-Nippon Ink Chemical Industry), and a mechanism of spring drive B of the tester is employed.

A: 260 cm/sec or higher.

B: From 220 cm/sec to lower than 260 cm/sec.

C: From 180 cm/sec to lower than 220 cm/sec.

D: Lower than 180 cm/sec.

TABLE 1

| | | | Silyl group functionalized | | | | | | | Hydrolysis | |
|---|---|---|---|---|---|---|---|---|---|---|---|
| | | | Monomer | | | Initiator | | | | Condition | |
| | | | | Concentration | | | Concentration | | Solid | Solid | NaOH |
| Type of | | | | of MeOH | Amount | | of MeOH | Amount | Concentration | Concentration | Molar |
| PVA | VAc¹⁾ | MeOH¹⁾ | Type | Solution (%) | Added¹⁾ | Type | Solution (%) | Added¹⁾ | (%) | (%) | ratio |
| PVA1 | 625 | 414 | VMS | 2.0 | 188 | AMV | 0.13 | 23 | 25 | 35 | 0.02 |
| PVA2 | 1000 | 179 | VMS | 4.0 | 60 | AMV | 0.13 | 11 | 32 | 30 | 0.02 |
| PVA16 | 625 | 600 | — | — | 188 | AMV | 0.13 | 23 | 25 | 35 | 0.02 |
| PVA17 | 1000 | 240 | — | — | 60 | AMV | 0.13 | 11 | 32 | 30 | 0.02 |

VMS: vinyltrimethoxysilane
AMV: 2,2′-azobis(4-methoxy-2,4-dimethylvaleronitrile)
¹⁾parts/hr

TABLE 2

| | | | Silyl group | | | Initiator Addition to | | | Solid | Initiator Addition to | | | | | |
|---|---|---|---|---|---|---|---|---|---|---|---|---|---|---|---|
| | | | functionalized Monomer | | | Polymerization Reactor 1 | | | Concen- | Polymerization Reactor 2 | | | Solid | | |
| | | | | Concen- | | | Concen- | | tration | | Concen- | | Concen- | Hydrolysis | |
| | | | | tration | | | tration | | in | | tration | | tration in | Condition | |
| | | | | of | | | of | | Polymer | | of | | Polymer- | Solid | |
| | | | | MeOH | | | MeOH | | ization | | MeOH | | ization | Concen- | NaOH |
| Type of | | | | Solution | Amount | | Solution | Amount | Reactor | | Solution | Amount | Reactor 2 | tration | molar |
| PVA | VAc¹⁾ | MeOH¹⁾ | Type | (%) | Added¹⁾ | Type | (%) | Added¹⁾ | 1 (%) | Type | (%) | Added¹⁾ | (%) | (%) | ratio |
| PVA3 | 500 | 588 | VMS | 2.0 | 150 | AMV | 0.13 | 4 | 10 | AMV | 0.13 | 8 | 24 | 35 | 0.02 |
| PVA4 | 1000 | 181 | VMS | 4.0 | 60 | AMV | 0.13 | 7 | 24 | AMV | 0.13 | 2 | 44 | 30 | 0.02 |
| PVA18 | 750 | 234 | VMS | 2.0 | 225 | AMV | 0.13 | 1 | 6 | AMV | 0.13 | 40 | 46 | 35 | 0.02 |
| PVA19 | 1100 | 60 | VMS | 4.0 | 66 | AMV | 0.13 | 4 | 18 | AMV | 0.13 | 20 | 57 | 30 | 0.02 |

VMS: vinyltrimethoxysilane
AMV: 2,2′-azobis(4-methoxy-2,4-dimethylvaleronitrile)
¹⁾parts/hr

TABLE 3

| | | | Silyl group functionalized Monomer | | | | | | | | Hydrolysis | |
|---|---|---|---|---|---|---|---|---|---|---|---|---|
| | | | | Concen- | | | | | Polymerization Condition | | Condition | |
| | | | | tration | | | Initiator | | | Solid | Solid | |
| Type | Initial Feeding | | | of MeOH | Amount of | Amount of | | Amount of | | Concen- | Concen- | NaOH |
| of | VAc | MeOH | | Solution | Initial Feed | Additional | | Initial Feed | Polymerization | tration | tration | molar |
| PVA | (parts) | (parts) | Type | (%) | (parts) | Feed (parts) | Type | (parts) | Time (hr) | (%) | (%) | ratio |
| PVA5 | 1050 | 2056 | VMS | 2.0 | 394 | 30 | AIBN | 1.3 | 4.0 | 15.2 | 35 | 0.02 |
| PVA6 | 2275 | 543 | VMS | 1.0 | 682 | 36 | AIBN | 0.5 | 4.0 | 22.7 | 30 | 0.02 |
| PVA7 | 2800 | 700 | AMPTMS | 3.0 | 8 | 47 | AIBN | 0.4 | 4.0 | 19.7 | 25 | 0.02 |
| PVA8 | 1400 | 1574 | VMS | 2.0 | 526 | 67 | AIBN | 4.2 | 6.0 | 33.6 | 35 | 0.02 |
| PVA9 | 2800 | 280 | VMS | 2.0 | 420 | 49 | AIBN | 1.5 | 6.0 | 61.7 | 30 | 0.02 |
| PVA20 | 2275 | 655 | VMS | 3.0 | 570 | 26 | AIBN | 0.5 | 4.0 | 19.8 | 30 | 0.02 |
| PVA21 | 1050 | 2136 | VMS | 0.1 | 314 | 24 | AIBN | 1.1 | 4.0 | 14.9 | 30 | 0.02 |

VMS: vinyltrimethoxysilane
AMPTMS: 2-acrylamido-2-methylpropyltrimethoxysilane
AIBN: 2,2′-azobisisobutyronitrile

TABLE 4

| | Silyl group | Weight-Average | | | | | |
|---|---|---|---|---|---|---|---|
| | functionalized | Degree | | | | | |
| Type of | Monomer | of Polymerization | | | Degree of | (A − B)/ | pH of |
| PVA | Content (mol %) | (Pw) | Pw * 3 (%)¹⁾ | Pw * 1/2 (%)²⁾ | Hydrolysis (mol %) | (B) | Aqueous 4% Solution |
| PVA1 | 0.50 | 580 | 19.9 | 9.1 | 98.5 | 10.9/100 | 6.0 |
| PVA2 | 0.20 | 1940 | 19.9 | 9.0 | 98.3 | 11.2/100 | 6.0 |
| PVA3 | 0.50 | 590 | 22.2 | 10.2 | 98.2 | 9.6/100 | 6.0 |
| PVA4 | 0.20 | 1900 | 19.1 | 10.3 | 98.7 | 14.5/100 | 6.0 |
| PVA5 | 0.50 | 560 | 19.9 | 9.9 | 98.5 | 10.9/100 | 6.0 |
| PVA6 | 0.20 | 1890 | 19.8 | 9.3 | 98.7 | 9.2/100 | 6.0 |
| PVA7 | 0.10 | 2840 | 19.3 | 9.3 | 98.2 | 0.7/100 | 6.0 |
| PVA8 | 0.50 | 620 | 20.8 | 14.9 | 98.5 | 10.3/100 | 6.0 |
| PVA9 | 0.20 | 1980 | 20.2 | 13.0 | 98.6 | 12.1/100 | 6.0 |
| PVA10 | 0.50 | 580 | 19.9 | 9.1 | 91.7 | 12.1/100 | 6.0 |
| PVA11 | 0.20 | 1940 | 19.9 | 9.0 | 92.3 | 10.1/100 | 6.0 |
| PVA12 | 0.20 | 1940 | 19.9 | 9.0 | 98.5 | 54.0/100 | 6.0 |
| PVA13 | 0.20 | 1940 | 19.9 | 9.0 | 98.1 | 0.04/100 | 6.0 |
| PVA14 | 0.20 | 1940 | 19.9 | 9.0 | 98.2 | 14.5/100 | 3.0 |
| PVA15 | 0.20 | 1940 | 19.9 | 9.0 | 99.3 | 7.2/100 | 8.5 |
| PVA16 | — | 600 | 19.8 | 8.9 | 98.5 | — | 6.0 |
| PVA17 | — | 2010 | 19.7 | 9.2 | 98.5 | — | 6.0 |
| PVA18 | 0.50 | 620 | 29.8 | 8.3 | 98.5 | 10.9/100 | 6.0 |
| PVA19 | 0.20 | 1940 | 26.1 | 9.7 | 98.4 | 12.2/100 | 6.0 |
| PVA20 | 0.50 | 1890 | 19.8 | 9.3 | 98.5 | 10.9/100 | 6.0 |
| PVA21 | 0.02 | 560 | 19.9 | 9.9 | 98.2 | 0.7/100 | 6.0 |
| PVA22 | — | 600 | 19.8 | 8.9 | 92.3 | — | 6.0 |
| PVA23 | — | 2010 | 19.7 | 9.2 | 91.9 | — | 6.0 |

¹⁾Weight fraction (%) of polymer molecules of which the degree of polymerization are more than 3 times the weight-average degree of polymerization of the whole PVA molecules.
²⁾Weight fraction (%) of polymer molecules of which the degree of polymerization are less than 1/2 times the weight-average degree of polymerization of the whole PVA molecules.

TABLE 5

| | | Viscosity | | | |
|---|---|---|---|---|---|
| | | Stability of | | Water-resistance of | |
| | | Aqueous PVA | Water-resistance of | PVA Film with | Binding Force of |
| | Type of PVA | Solution | PVA Film | Inorganic Substance | PVA |
| Example 1 | PVA1 | A | A | A | A |
| Example 2 | PVA2 | A | A | A | A |
| Example 3 | PVA3 | A | A | A | A |
| Example 4 | PVA4 | A | A | A | A |
| Example 5 | PVA5 | A | A | A | A |
| Example 6 | PVA6 | A | A | A | A |
| Example 7 | PVA7 | A | A | A | A |
| Example 8 | PVA8 | B | B | B | B |
| Example 9 | PVA9 | B | B | B | B |
| Example 10 | PVA10 | A | B | B | B |
| Example 11 | PVA11 | A | B | B | B |
| Example 12 | PVA12 | B | B | B | B |
| Example 13 | PVA13 | B | B | B | B |
| Example 14 | PVA14 | B | B | B | B |
| Example 15 | PVA15 | B | B | B | B |
| Comp. Ex. 1 | PVA16 | A | A | D | D |
| Comp. Ex. 2 | PVA17 | A | A | D | D |
| Comp. Ex. 3 | PVA18 | C | A | C | C |
| Comp. Ex. 4 | PVA19 | C | A | C | C |
| Comp. Ex. 5 | PVA20 | —¹⁾ | —¹⁾ | —¹⁾ | —¹⁾ |
| Comp. Ex. 6 | PVA21 | A | A | D | D |
| Comp. Ex. 7 | PVA22 | A | C | D | D |
| Comp. Ex. 8 | PVA23 | A | C | D | D |

¹⁾Evaluation was impossible since PVA did not dissolve in an aqueous solution.

From the results in Table 5, it is understood that the polyvinyl alcohol of the invention has well-balanced properties of good viscosity stability of its aqueous solution, good water-resistance of its film, good water-resistance of its film with an inorganic substance, and good binding force with inorganic substances (Examples 1 to 15). In particular, when the polyvinyl alcohol satisfies the above-mentioned formula (II), 0.1/100≦(A−B)/(B)≦50/100 and the pH of its aqueous 4% solution falls between 4 and 8, and when the weight fraction of the polymer molecules of which the degree of polymerization are smaller than 3 times the weight-average degree of polymerization Pw of the whole PVA molecules is 12% by weight or less, then the balance of the physical properties of the polyvinyl alcohol is better (Examples 1 to 7, and Examples 10 and 11).

In addition, since the water-resistance of the film of the polyvinyl alcohol of the invention with an inorganic substance therein is good and since the binding force of the polyvinyl alcohol of the invention with inorganic substances is high, the polyvinyl alcohol of the invention is favorable for the binder in the ink-receiving layer in inkjet recording materials.

On the other hand, the polyvinyl alcohol, of which Pw (weight-average degree of polymerization of polyvinyl alcohol)×S (silyl group functionalized monomer content of polyvinyl alcohol) is not larger than 20, is not good in point of the water-resistance of its film with an inorganic substance and of its binding force with inorganic substances (Comparative Example 6); and the polyvinyl alcohol of which Pw×S is not smaller than 460 could not completely dissolve in water and therefore could not be evaluated (Comparative Example 5).

In addition, it is further understood that the polyvinyl alcohol, of which the weight fraction of the polymer molecules having degree of polymerization that are more than 3 times the weight-average degree of polymerization Pw of the whole polyvinyl alcohol molecules is more than 25% by weight, is not also good in point of the viscosity stability of its aqueous solution, the water-resistance of its film with an inorganic substance and its binding force with inorganic substances (Comparative Examples 3 and 4).

It is also understood that the polyvinyl alcohol with no silyl group functionalized monomer therein is not good in point of the water-resistance of its film with an inorganic substance and its binding force with inorganic substances (Comparative Examples 1, 2, 7 and 8).

II. Inkjet Recording Paper

Inkjet recoding paper was fabricated according to the method mentioned below, and its surface strength of ink-receiving layer was evaluated. Its print quality and water-resistance were also evaluated in the case of printing on the inkjet recording paper by using an inkjet printer.

### Example 16

Aqueous 10% PVA1 solution was prepared. Silica (Grace Davison's SYLOID 162) was dispersed in water by the use of a homogenizer to prepare an aqueous dispersion of 20% silica. To the aqueous silica dispersion, added was an aqueous 10% PVA1 solution and cationic polymer (Sumitomo Chemical's Sumirez Resin 1001) in such a manner that the solid content-based ratio by weight of silica/PVA/cationic polymer may be 100/55/3, and a necessary amount of water was added thereto to prepare a coating liquid having a solid concentration of 14% for an ink-receiving layer.

Using a BL-type viscometer, the liquid was measured at 40° C. and at 30 rpm. Immediately after its preparation, the viscosity of the coating liquid was 480 mPa.s. After left at 40° C. for 1 week, the viscosity was 1.92 times that of the coating liquid just after its preparation, or that is, there was found little viscosity change before and after the storage of the coating liquid and the viscosity stability thereof was good.

The above-mentioned coating liquid for ink-receiving layer was applied onto the surface of base paper (woodfree paper having a weight of 60 g/m²), using a wire bar coater, and its coating amount was 11 g/m² in terms of the solid content thereof. This was dried with a hot air drier at 100° C. for 3 minutes to be an inkjet recording paper.

Surface Strength of Ink-Receiving Layer:

Using an IGT printability tester, the given inkjet recording paper was tested under a printing pressure of 25 kg/cm². The printing speed (cm/sec) at which the surface of the inkjet recording paper has peeled was read, and this indicated the surface strength of the paper. From it, the surface strength of ink-receiving layer tested herein was evaluated according to the criteria mentioned below. In testing the paper with the IGT printability tester, used was IGT Pick Oil M (by Dai-Nippon Ink Chemical Industry), and a mechanism of spring drive B of the tester was employed.

A: 260 cm/sec or higher.

B: From 220 cm/sec to lower than 260 cm/sec.

C: From 180 cm/sec to lower than 220 cm/sec.

D: Lower than 180 cm/sec.

Print Quality:

A section of a given inkjet recording-paper was painted out by using an inkjet printer (EPSON's PM-3300C) with black ink, and then print quality was observed. This was evaluated according to the criteria mentioned below.

A: The image density was uniform in the whole image area and the printed image was good.

B: Little unevenness of image density was observed and the printed image was not almost damaged.

C: Unevenness of image density was occurred in a part of the image area and the quality of printed image was lowered.

D: Unevenness of image density was occurred in the whole image area and the quality of printed image was extremely lowered.

Water-Resistance:

A section of a given inkjet recording paper was painted out by using an inkjet printer (EPSON's PM-3300C) with black ink. 1 ml of water was dropped on the edge of the printed area by syringe. The paper was left for 24 hours, and then was observed the extent of blur in the area spotted with water. This was evaluated according to the following criteria:

A: No blur was observed.

B: Blur was scarcely observed.

C: Blur was partly spread.

D: Blur was entirely spread in the area spotted with water.

### Examples 17 to 30

Inkjet recording paper was fabricated in the same manner as in Example 16, for which, however, the silyl group functionalized PVAs shown in Table 6 were used in place of the silyl group functionalized PVAs used in Example 16. The surface strength of ink-receiving layer of the paper, and the print quality and water resistance of the paper printed with an inkjet printer were evaluated. The results are shown in Table 6.

### Comparative Examples 9 to 16

Inkjet recording paper was fabricated in the same manner as in Example 16, for which, however, the PVAs shown in Table 6 were used in place of the silyl group functionalized PVAs used in Example 16. The surface strength of ink-receiving layer of the paper, and the print quality and water resistance of the paper printed with an inkjet printer were evaluated. The results are shown in Table 6.

TABLE 6

| | | | Coating Liquid | | | | |
|---|---|---|---|---|---|---|---|
| | Type of | PVA/ | for Ink-receiving Layer | | Surface Strength of | | |
| | PVA | Silica | Viscosity¹⁾ | Viscosity change²⁾ | Ink-Receiving Layer | Print Quality | Water-resistance |
| Example 16 | PVA1 | 55/100 | 480 | 1.92 | A | A | A |
| Example 17 | PVA2 | 35/100 | 560 | 2.13 | A | A | A |
| Example 18 | PVA3 | 50/100 | 420 | 2.42 | A | A | A |
| Example 19 | PVA4 | 30/100 | 550 | 2.38 | A | A | A |
| Example 20 | PVA5 | 60/100 | 510 | 2.01 | A | A | A |
| Example 21 | PVA6 | 30/100 | 550 | 2.21 | A | A | A |
| Example 22 | PVA7 | 5/100 | 280 | 2.26 | A | A | B |
| Example 23 | PVA8 | 80/100 | 810 | 3.14 | B | B | B |
| Example 24 | PVA9 | 20/100 | 490 | 3.41 | B | A | B |
| Example 25 | PVA10 | 60/100 | 510 | 2.09 | B | A | B |
| Example 26 | PVA11 | 30/100 | 530 | 1.98 | B | A | B |
| Example 27 | PVA12 | 15/100 | 450 | 3.30 | B | A | B |
| Example 28 | PVA13 | 20/100 | 480 | 3.41 | B | A | B |
| Example 29 | PVA14 | 30/100 | 560 | 2.86 | B | A | B |
| Example 30 | PVA15 | 35/100 | 570 | 2.91 | B | A | B |
| Comp. Example 9 | PVA16 | 100/100 | 690 | 1.98 | D | C | D |
| Comp. Example 10 | PVA17 | 5/100 | 260 | 2.19 | D | C | D |
| Comp. Example 11 | PVA18 | 50/100 | 450 | 8.20 | C | A | C |
| Comp. Example 12 | PVA19 | 30/100 | 550 | 11.06 | C | A | C |
| Comp. Example 13 | PVA20 | 30/100 | 540 | —³⁾ | —³⁾ | —³⁾ | —³⁾ |
| Comp. Example 14 | PVA21 | 80/100 | 790 | 2.26 | D | D | D |
| Comp. Example 15 | PVA22 | 80/100 | 750 | 2.31 | D | C | D |
| Comp. Example 16 | PVA23 | 15/100 | 410 | 2.40 | D | A | D |

¹⁾The viscosity of the coating liquid measured with a BL-type viscometer at 40° C. and at 30 rpm, just after the preparation thereof. (unit: mPa · s)
²⁾(viscosity of coating liquid left at 40° C. for 1 week)/(viscosity of coating liquid just after its preparation).
³⁾PVA did not completely dissolve in an aqueous solution.

From the results in Table 6, it is understood that the inkjet recording paper in which the polyvinyl alcohol of the invention is used for the binder in the ink-receiving layer has high surface strength of ink-receiving layer, and also has good print quality and good water-resistance when the recording paper is printed by using an inkjet printer (Examples 16 to 30).

In particular, the properties of the inkjet recording paper is better in case that the polyvinyl alcohol used for the binder in the ink-receiving layer satisfies the above-mentioned formula (II), 0.1/100≦(A−B)/(B)≦50/100, the pH of 4% aqueous solution of the polyvinyl alcohol falls between 4 and 8, the weight fraction of the polymer molecules of which the degree of polymerization are smaller than ½ times the weight-average degree of polymerization Pw of the whole PVA molecules is 12% by weight or less, and the degree of hydrolysis is more than 95 mol % (Examples 16 to 22).

As opposed to these, when the polyvinyl alcohol of which Pw (weight-average degree of polymerization of polyvinyl alcohol)×S (silyl group functionalized monomer unit content of polyvinyl alcohol) is 20 or less is used for the binder in the ink-receiving layer, the surface strength of ink-receiving layer is not good and the print quality and water-resistance of the inkjet recording paper are also not good (Comparative Example 14); and the polyvinyl alcohol of which Pw×S is 460 or more could not completely dissolve in water and therefore could not be evaluated (Comparative Example 13).

Further, it is understood that when the polyvinyl alcohol, in which the weight fraction of the polyvinyl alcohol molecules of which the degree of polymerization are more than 3 times the weight-average degree of polymerization of the whole polyvinyl alcohol molecules is over 25% by weight, is used for the binder in the ink-receiving layer, the surface strength of the ink-receiving layer is not good and the water-resistance of the recording paper is not good (Comparative Example 11 and 12).

It is also understood that in the case of using the polyvinyl alcohol with no silyl group functionalized monomer therein for the binder of ink-receiving layer, the surface strength of ink-receiving layer is poor and the print quality and water-resistance of the inkjet recording paper are poor (Comparative Examples 9, 10, 15 and 16).

III. Thermal Recording Paper

Thermal recoding paper was fabricated according to the method mentioned below, and its water-resistance and plasticizer resistance were evaluated.

### Example 31

(1) Preparation of Aqueous Dispersions of Thermo-Sensitive Dye, Developer and Pigment:

Composition of Aqueous Dispersion A of Thermo-Sensitive Dye:

| Composition of aqueous dispersion A of | |
|---|---|
| thermo-sensitive dye: | |
| Leuco dye (Yamamoto Chemical's OBD-2) | 20% |
| Aqueous solution of 10% PVA (Kuraray's PVA203) | 20% |
| Water | 60% |
| Composition of aqueous dispersion B of developer: | |
| Developer (Nippon Soda's D-8) | 20% |
| Aqueous solution of 10% PVA (Kuraray's PVA203) | 20% |
| Water | 60% |
| Composition of aqueous dispersion C of pigment: | |
| Stearamide | 10% |
| Calcined kaolin | 20% |
| Aqueous solution of 5% PVA (Kuraray's PVA205) | 30% |
| Water | 40% |

Aqueous dispersion A, aqueous dispersion B and aqueous dispersion C each having the composition mentioned above were prepared separately, and each was pre-stirred in a beaker for 15 minutes.

Next, the aqueous dispersion A was transferred into a sand grinder (Kansai Paint's batch-type desktop sand grinder), to which were added 300 ml of glass beads (soda-quartz glass beads having a diameter of 0.5 mm), and this was rotated at a high revolution (2170 rpm) with cooling for 6 hours to disperse the dispersoid. This was analyzed with a laser diffraction-type grain size analyzer (Shimadzu's SALD-1000), and the dispersoid particle size of the aqueous dispersion A of thermo-sensitive dye was 0.46 μm. In addition, this was analyzed with a color difference meter (Nippon Denshoku Kogyo's Z-1001DP), and the degree of whiteness of the aqueous dispersion A was −8.1. Regarding the degree of whiteness, 0 means that the sample analyzed is completely white, and a larger minus value means that the sample analyzed is colored more.

In the same manner, the aqueous dispersion B was transferred into a sand grinder of the same type, to which were added 300 ml of glass beads (soda-quartz glass beads having a diameter of 0.5 mm), and this was rotated at a high revolution (2170 rpm) with cooling for 6 hours to disperse the dispersoid.

The aqueous dispersion C was transferred into a homogenizer, and its dispersoid was dispersed at a revolution of 10000 rpm for 2 minutes.

(2) Preparation of Coating Liquid for Thermo-Sensitive Coloring Layer:

2 parts of the aqueous dispersion A, 4 parts of the aqueous dispersion B, 2 parts of the aqueous dispersion C and 2 parts of an aqueous solution of 10% PVA5 were mixed and stirred, to which a necessary amount of water was added to prepare a coating liquid having a solid concentration of 21% for a thermo-sensitive coloring layer.

Using a BL-type viscometer, the liquid was measured at 25° C. and at 30 rpm. Immediately after its preparation, the viscosity of the coating liquid was 280 mPa.s. After left at 25° C. for 1 week, the viscosity was 1.10 times that of the coating liquid just after its preparation, or that is, there was found little viscosity change before and after the storage of the coating liquid and the viscosity stability thereof was good.

(3) Preparation of Coating Liquid for Overcoat Layer:

72.5 parts of water was added to 0.2 part of ethylene glycol-propylene glycol copolymer (Nippon Yushi's Pronon 104) and 50 parts of silica (Shionogi's Carplex CS-5). With fully dispersing it, 690 parts of an aqueous solution of 12% PVA1 was gradually added to it at room temperature, and then 7.5 parts of zinc stearate dispersion (Chukyo Yushi's Hidrin Z730, having a solid concentration of 30%) was added thereto to prepare an aqueous dispersion of PVA1 with silica.

With stirring the aqueous dispersion of PVA1 with silica thus prepared, 30 parts of an aqueous solution of 10% titanium lactate was gradually added thereto at room temperature, to which a necessary amount of water was added to prepare a coating liquid for a overcoat layer having a solid concentration of 15%.

Using a BL-type viscometer, the liquid was measured at 25° C. and at 30 rpm. Immediately after its preparation, the viscosity of the coating liquid was 360 mPa.s. After left at 25° C. for 1 week, the viscosity was 1.21 times that of the coating liquid just after its preparation, or that is, there was found little viscosity change before and after the storage of the coating liquid and the viscosity stability thereof was good.

(4) Fabrication of Thermal Recording Paper:

The coating liquid for thermo-sensitive coloring layer that had been prepared in the above (2) was applied onto the surface of base paper (woodfree paper having a weight of 52 g/m²), using a wire bar coater, and its coating amount was 6 g/m² in terms of the solid content thereof This was dried at 50° C. for 5 minutes. The coated paper was surface-treated with a supercalender (linear pressure: 30 kg/cm). Then, the coating liquid for overcoat layer that had been prepared in the above (3) was applied onto the surface of the coated paper, using a wire bar coater, and its coating amount was 3 g/m² in terms of the solid content thereof. This was dried at 50° C. for 10 minutes. The coated paper was surface-treated with a supercalender (linear pressure: 30 kg/cm) to be thermal recording paper.

Immediately after its fabrication, the thermal recording paper was set in a thermal printer for facsimiles (Ricoh's Refax 300) and printed thereon, and its water-resistance and plasticizer resistance were evaluated according to the methods mentioned below. The results are shown in Table 7.

Water-Resistance:

The printed paper was dipped in distilled water at 30° C. for 24 hours, and then its image density and wet rubbing resistance were evaluated in the manner mentioned below.

Image Density:

Before and after dipped in distilled water, the color density of the image area of the printed paper was measured with a Macbeth densitometer (Macbeth's Model RD-514). In point of water resistance, it was better for the thermal recording paper having kept higher image density after dipped in distilled water. Based on this, the samples were ranked into five ranks, from 1 (the worst) to 5 (the best).

Wet Rubbing Resistance:

The surface of the image area of the printed paper was rubbed with fingers, and checked for an amount of the coating which was come off on fingers. In view of water resistance, it was better for the thermal recording paper that the amount of the coating come off on fingers was less. Based on this, the samples were ranked into five ranks, from 1 (the worst) to 5 (the best).

Plasticizer Resistance:

A soft polyvinyl chloride film was put on the printed paper, and kept at 30° C. under a load of 300 g/m² for 24 hours. The image density of the thus-tested paper was measured with a Macbeth densitometer (Macbeth's Model RD-514) and compared with that of the paper before the test. In point of Plasticizer resistance, it was better for the thermal recording paper having kept higher image density after contact with a soft polyvinyl chloride. Based on this, the samples were ranked into five ranks, from 1 (the worst) to 5 (the best).

### Examples 32 to 48

Thermal recording paper was fabricated in the same manner as in Example 31, for which, however, the silyl group functionalized PVAs shown in Table 7 were used in place of the silyl group functionalized PVAs used in Example 31, and its water-resistance and plasticizer resistance were evaluated. The results are shown in Table 7.

### Example 49

(1) Preparation of Aqueous Dispersions of Thermo-Sensitive Dye, Developer and Pigment:

Composition of Aqueous Dispersion A of Thermo-Sensitive Dye:

| Composition of aqueous dispersion A of | |
|---|---|
| thermo-sensitive dye: | |
| Leuco dye (Yamamoto Chemical's OBD-2) | 20% |
| Aqueous solution of 10% PVA (Kuraray's PVA203) | 20% |
| Water | 60% |
| Composition of aqueous dispersion B of developer: | |
| Developer (Nippon Soda's D-8) | 20% |
| Aqueous solution of 10% PVA (Kuraray's PVA203) | 20% |
| Water | 60% |
| Composition of aqueous dispersion C of pigment: | |
| Stearamide | 10% |
| Calcined kaolin | 20% |
| Aqueous solution of 5% PVA (Kuraray's PVA 205) | 30% |
| Water | 40% |

Aqueous dispersion A, aqueous dispersion B and aqueous dispersion C each having the composition mentioned above were prepared separately, and each was pre-stirred in a beaker for 15 minutes.

Next, the aqueous dispersion A was transferred into a sand grinder (Kansai Paint's batch-type desktop sand grinder), to which were added 300 ml of glass beads (soda-quartz glass beads having a diameter of 0.5 mm), and this was rotated at a high revolution (2170 rpm) with cooling for 6 hours to disperse the dispersoid. This was analyzed with a laser diffraction-type grain size analyzer (Shimadzu's SALD-1000), and the dispersoid particle size of the aqueous dispersion A of thermo-sensitive dye was 0.46 μm. In addition, this was analyzed with a color difference meter (Nippon Denshoku Kogyo's Z-1001DP), and the degree of whiteness of the aqueous dispersion A was −8.1.

In the same manner, the aqueous dispersion B was transferred into a sand grinder of the same type, to which were added 300 ml of glass beads (soda-quartz glass beads having a diameter of 0.5 mm), and this was rotated at a high revolution (2170 rpm) with cooling for 6 hours to disperse the dispersoid.

The aqueous dispersion C was transferred into a homogenizer, and its dispersoid was dispersed at a revolution of 10000 rpm for 2 minutes.

(2) Preparation of Coating Liquid for Thermo-Sensitive Coloring Layer:

2 parts of the aqueous dispersion A, 4 parts of the aqueous dispersion B, 2 parts of the aqueous dispersion C and 2 parts of an aqueous solution of 10% PVA1 were mixed and stirred, to which 0.3 part of an aqueous solution of 10% titanium lactate was slowly added at room temperature and a necessary amount of water was added, to prepare a coating liquid having a solid concentration of 21% for a thermo-sensitive coloring layer.

Using a BL-type viscometer, the liquid was measured at 25° C. and at 30 rpm. Immediately after its preparation, the viscosity of the coating liquid was 310 mPa.s. After left at 25° C. for 1 week, the viscosity was 1.19 times that of the coating liquid just after its preparation.

(3) Fabrication of Thermal Recording Paper:

The coating liquid for thermo-sensitive coloring layer that had been prepared in the above (2) was applied onto the surface of base paper (woodfree paper having a weight of 52 g/m²), using a wire bar coater, and its coating amount was 6 g/m² in terms of the solid content thereof. This was dried at 50° C. for 5 minutes. The coated paper was surface-treated with a supercalender (linear pressure: 30 kg/cm) to be thermal recording paper. Its water-resistance and plasticizer resistance were evaluated in the same manner as in Example 31. The results are shown in Table 7.

### Examples 50 and 51

Thermal recording paper was fabricated in the same manner as in Example 49, for which, however, the silyl group functionalized PVAs shown in Table 7 were used in place of the silyl group functionalized PVAs used in Example 49, and its water-resistance and plasticizer resistance were evaluated. The results are shown in Table 7.

### Comparative Examples 17 to 24

Thermal recording paper was fabricated in the same manner as in Example 31, for which, however, the PVAs shown in Table 8 were used in place of the silyl group functionalized PVAs used in Example 31, and its water-resistance and plasticizer resistance were evaluated. The results are shown in Table 8.

### Comparative Examples 25 to 27

Thermal recording paper was fabricated in the same manner as in Example 49, for which, however, the PVAs shown in Table 8 were used in place of the silyl group functionalized PVAs used in Example 49, and its water-resistance and plasticizer resistance were evaluated. The results are shown in Table 8.

TABLE 7

| | | Coating Liquid for | | | | | | | |
|---|---|---|---|---|---|---|---|---|---|
| | | Thermo-sensitive | | | Coating Liquid for | | | | |
| | PVA used in | coloring layer | | PVA used | Overcoat layer | | Water-resistance | | |
| | Thermo-sensitive | | Viscosity | in Overcoat | | Viscosity | | Wet Rubbing | Plasticizer |
| | coloring layer | Viscosity¹⁾ | Change²⁾ | layer | Viscosity¹⁾ | Change²⁾ | Image Density | Resistance | Resistance |
| Example 31 | PVA5 | 280 | 1.10 | PVA1 | 360 | 1.21 | 5 | 5 | 4 |
| Example 32 | PVA5 | 280 | 1.10 | PVA2 | 650 | 1.09 | 5 | 5 | 5 |
| Example 33 | PVA5 | 280 | 1.10 | PVA3 | 360 | 1.20 | 5 | 4 | 4 |
| Example 34 | PVA5 | 280 | 1.10 | PVA4 | 650 | 1.10 | 5 | 5 | 5 |
| Example 35 | PVA10 | 270 | 1.09 | PVA5 | 360 | 1.61 | 5 | 5 | 4 |
| Example 36 | PVA10 | 270 | 1.09 | PVA6 | 630 | 1.07 | 5 | 5 | 5 |
| Example 37 | PVA10 | 270 | 1.09 | PVA7 | 840 | 1.81 | 5 | 5 | 5 |
| Example 38 | PVA5 | 280 | 1.10 | PVA8 | 360 | 2.61 | 4 | 4 | 4 |
| Example 39 | PVA5 | 280 | 1.10 | PVA9 | 660 | 3.02 | 4 | 4 | 5 |
| Example 40 | PVA10 | 270 | 1.09 | PVA10 | 310 | 1.40 | 4 | 4 | 4 |
| Example 41 | PVA10 | 270 | 1.09 | PVA11 | 600 | 1.05 | 4 | 4 | 5 |
| Example 42 | PVA5 | 280 | 1.10 | PVA12 | 650 | 3.12 | 4 | 4 | 5 |
| Example 43 | PVA5 | 280 | 1.10 | PVA13 | 650 | 2.96 | 4 | 4 | 5 |
| Example 44 | PVA5 | 280 | 1.10 | PVA14 | 650 | 3.06 | 4 | 4 | 5 |
| Example 45 | PVA5 | 280 | 1.10 | PVA15 | 630 | 1.12 | 4 | 4 | 5 |
| Example 46 | PVA1 | 280 | 1.10 | PVA17 | 580 | 1.03 | 3 | 3 | 4 |
| Example 47 | PVA5 | 280 | 1.10 | PVA19 | 610 | 6.21 | 3 | 3 | 4 |
| Example 48 | PVA10 | 270 | 1.09 | PVA23 | 560 | 1.02 | 3 | 3 | 4 |

| | | | | | | | |
|---|---|---|---|---|---|---|---|
| Example 49 | PVA1 | 310 | 1.19 | —³⁾ | 3 | 3 | 3 |
| Example 50 | PVA5 | 300 | 1.27 | —³⁾ | 3 | 3 | 3 |
| Example 51 | PVA10 | 310 | 1.22 | —³⁾ | 3 | 3 | 3 |

¹⁾The viscosity of the coating liquid measured with a BL-type viscometer at 25° C. and at 30 rpm, just after the preparation thereof. (unit: mPa · s)
²⁾(viscosity of coating liquid left at 25° C. for 1 week)/(viscosity of coating liquid just after its preparation).
³⁾Overcoat layer was absent.

TABLE 8

| | | Coating Liquid for | | | | | | | |
|---|---|---|---|---|---|---|---|---|---|
| | | Thermo-sensitive | | | Coating Liquid for | | | | |
| | PVA used in | coloring layer | | PVA used | Overcoat layer | | Water-resistance | | |
| | Thermo-sensitive | | Viscosity | in Overcoat | | Viscosity | Image | Wet Rubing | Plasticizer |
| | coloring layer | Viscosity¹⁾ | Change²⁾ | layer | Viscosity¹⁾ | Change²⁾ | Density | Resistance | Resistance |
| Comp. Ex. 17 | PVA21 | 260 | 1.10 | PVA16 | 290 | 1.01 | 1 | 1 | 4 |
| Comp. Ex. 18 | PVA21 | 260 | 1.10 | PVA17 | 580 | 1.03 | 1 | 1 | 5 |
| Comp. Ex. 19 | PVA21 | 260 | 1.10 | PVA18 | 340 | 7.10 | 2 | 2 | 4 |
| Comp. Ex. 20 | PVA21 | 260 | 1.10 | PVA19 | 610 | 6.21 | 2 | 2 | 5 |
| Comp. Ex. 21 | PVA21 | 260 | 1.10 | PVA20 | —³⁾ | —³⁾ | —⁴⁾ | —⁴⁾ | —⁴⁾ |
| Comp. Ex. 22 | PVA21 | 260 | 1.10 | PVA21 | 350 | 2.13 | 1 | 1 | 4 |
| Comp. Ex. 23 | PVA21 | 260 | 1.10 | PVA22 | 270 | 1.01 | 1 | 1 | 4 |
| Comp. Ex. 24 | PVA21 | 260 | 1.10 | PVA23 | 560 | 1.02 | 1 | 1 | 5 |

| | | | | | | | |
|---|---|---|---|---|---|---|---|
| Comp. Ex. 25 | PVA16 | 300 | 1.11 | —⁵⁾ | 1 | 1 | 1 |
| Comp. Ex. 26 | PVA18 | 310 | 1.11 | —⁵⁾ | 1 | 1 | 1 |
| Comp. Ex. 27 | PVA21 | 270 | 1.12 | —⁵⁾ | 1 | 1 | 1 |

¹⁾The viscosity of the coating liquid measured with a BL-type viscometer at 25° C. and at 30 rpm, just after the preparation thereof. (unit: mPa · s)
²⁾(viscosity of coating liquid left at 25° C. for 1 week)/(viscosity of coating liquid just after its preparation).
³⁾PVA did not completely dissolve in an aqueous solution.
⁴⁾Uniform coating layer could not be prepared.
⁵⁾Overcoat layer was absent.

From the results in Table 7, it is understood that the thermal recording paper, in which the polyvinyl alcohol of the invention is used for at least one layer selected from the thermo-sensitive coloring layer and the overcoat layer, has good water-resistance and good plasticizer resistance (Examples 31 to 51).

In particular, the properties of the thermal recording paper is better in case that the polyvinyl alcohol used in the overcoat layer satisfies the above-mentioned formula (II), 0.1/100≦(A−B)/(B)≦50/100, the pH of 4% aqueous solution of the polyvinyl alcohol falls between 4 and 8, the weight fraction of the polymer molecules of which the degree of polymerization are smaller than ½ times the weight-average degree of polymerization Pw of the whole PVA molecules is 12% by weight or less, and the degree of hydrolysis of the polyvinyl alcohol is more than 95 mol % (Examples 31 to 37).

On the other hand, it is understood from the results in Table 8 that when the polyvinyl alcohol of the invention is used for neither thermo-sensitive coloring layer nor overcoat layer, at least either water-resistance or plasticizer resistance of the thermal recording paper is poor (Comparative Examples 17 to 27).

Of these, when the polyvinyl alcohol of which Pw (weight-average degree of polymerization of polyvinyl alcohol)×S (silyl group functionalized monomer unit content of polyvinyl alcohol) is 20 or less is used for the thermo-sensitive coloring layer and the overcoat layer, the water-resistance of the thermal recording paper is not good (Comparative Example 22); and the polyvinyl alcohol of which Pw×S is 460 or more could not completely dissolve in water and therefore could not be evaluated (Comparative Example 21).

In the case of using the polyvinyl alcohol, in which the weight fraction of the polyvinyl alcohol molecules of which the degree of polymerization are more than 3 times the weight-average degree of polymerization of the whole polyvinyl alcohol molecules is over 25% by weight, is used for the overcoat layer, the water-resistance of thermal recording paper is poor (Comparative Examples 19 and 20). When the polyvinyl alcohol with no silyl group functionalized monomer therein is used for both thermo-sensitive coloring layer and overcoat layer, the water-resistance is also poor (Comparative Examples 17, 18, 23 and 24).

Further, when the polyvinyl alcohol of the invention is not used for the thermo-sensitive coloring layer and the overcoat layer is absent, both water-resistance and plasticizer resistance of thermal recording paper is poor (Comparative Examples 25 to 27).

The silyl group functionalized polyvinyl alcohol of the invention can dissolve in water to prepare its aqueous solution even when an alkali such as sodium hydroxide or an acid is not added thereto, and, in addition, it satisfies all the requirements that the viscosity stability of the aqueous solution thereof is good, the water-resistance of the film formed of the aqueous solution thereof is good, the water-resistance of the film with an inorganic substance therein is also good, and the binding force thereof with inorganic substances is high. Therefore, the polyvinyl alcohol of the invention has many applications, and especially in excellent performance as coating agents to be combined with inorganic substances. And the coating agent that contains the silyl group functionalized polyvinyl alcohol of the invention is applied to substrates to produce inkjet recording material and thermal recording material having excellent properties such as water-resistance.

Japanese priority document 203146/2002 filed on Jul. 11, 2002 is incorporated herein by reference in its entirety.

Obviously, numerous modifications and variations of the present invention are possible in light of the above teachings. It is therefore to be understood that within the scope of the appended claims, the invention may be practiced otherwise than as specifically described herein.

What is claimed is:

1. A polyvinyl alcohol obtained by hydrolysis of a polyvinyl ester comprising polymerized silyl group functionalized monomer units of formula (1): 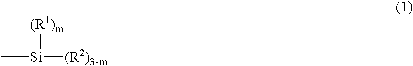
wherein R¹ represents an alkyl group having from 1 to 5 carbon atoms; R² represents an alkoxyl or acyloxyl group; and m is an integer of from 0 to 2,
which satisfies the following formulae (I):
20<Pw×S<460 (I)
wherein Pw is the weight average degree of polymerization of the polyvinyl alcohol; and S is the content (mol %) of the silyl group functionalized monomer units of formula (1) in the polyvinyl alcohol, and
wherein the weight fraction of the polyvinyl alcohol molecules having a degree of polymerization that is more than 3 times the weight-average degree of polymerization of the entire amount of polyvinyl alcohol is at most 25% by weight of the polyvinyl alcohol.

2. The polyvinyl alcohol as claimed in claim 1, wherein the weight fraction of the polymer molecules having a degree of polymerization that is smaller than ½ times the weight average degree of polymerization of the entire amount of polyvinyl alcohol is at most 12% by weight.

3. The polyvinyl alcohol as claimed in claim 1, which satisfies the following formula (II):
0.1/100≦(A−B)/(B)≦50/100 (II)
wherein A is the silicon atom content of the polyvinyl alcohol in ppm; B is the silicon atom content of the polyvinyl alcohol in ppm after the polyvinyl alcohol has been washed with a sodium hydroxide-containing methanol solution and then washed by Soxhlet extraction with methanol, and A and B are measured by ICP emission spectrometry of an ashed sample of the polyvinyl alcohol, and
wherein an aqueous 4% solution of the polyvinyl alcohol has a pH of from 4 to 8.

4. A coating agent that contains the polyvinyl alcohol of any one of claims 1 to 3.

5. A coated article produced by applying the coating agent of claim 4 to a substrate.

6. An inkjet recording material produced by applying the coating agent of claim 4 to a substrate.

7. A thermal recording material produced by applying the coating agent of claim 4 to a substrate.

8. The polyvinyl alcohol as claimed in claim 1, wherein R² is an alkoxyl or acyloxyl group having an oxygen-containing substituent.

9. The polyvinyl alcohol as claimed in claim 1, wherein
50<Pw×S<420.

10. The polyvinyl alcohol as claimed in claim 1, wherein
100<Pw×S<390.

11. The polyvinyl alcohol as claimed in claim 3, wherein
0.3/100≦(A−B)/(B)≦25/100.

12. The polyvinyl alcohol as claimed in claim 3, wherein
0.4/100≦(A−B)/(B)≦20/100.

13. The polyvinyl alcohol as claimed in claim 1 having a degree of hydrolysis of at least 98 mol %.

14. The polyvinyl alcohol as claimed in claim 1, wherein the hydrolyzed silyl group functionalized monomer units are present in an amount of from 0.05 to 1.0 mol %.

15. The polyvinyl alcohol as claimed in claim 1, wherein the hydrolyzed silyl group functionalized monomer units are present in an amount of from 0.2 to 0.5 mol %.

16. A method for producing the polyvinyl alcohol of claim 1, which comprises:
copolymerizing a vinyl ester monomer with a monomer having a silyl group of formula (I) to form a polyvinyl ester: 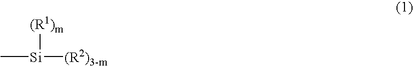
wherein R¹ represents an alkyl group having from 1 to 5 carbon atoms; R² represents an alkoxyl or acyloxyl group; and m is an integer of from 0 to 2,
and then hydrolyzing the polyvinyl ester.

17. The method as claimed in claim 16, wherein the monomer is represented by formula (2): 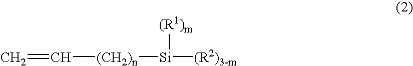
wherein R¹ represents an alkyl group having from 1 to 5 carbon atoms; R² represents an alkoxyl or acyloxyl group; m indicates an integer of from 0 to 2; and n is an integer of from 0 to 4,
or by formula (3): 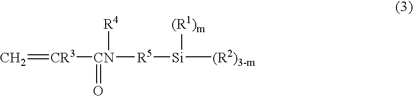
wherein R¹ represents an alkyl group having from 1 to 5 carbon atoms; R² represents an alkoxyl or acyloxyl group; R³ represents a hydrogen atom or a methyl group; R⁴ represents a hydrogen atom, or an alkyl group having from 1 to 5 carbon atoms; R⁵ represents an alkylene group having from 1 to 5 carbon atoms, or a divalent hydrocarbon group that contains an oxygen or nitrogen atom; and m is an integer of from 0 to 2.

18. The method as claimed in claim 16, wherein R² is an alkoxyl or acyloxyl group having an oxygen-containing substituent.

19. The method as claimed in claim 16, wherein the vinyl ester monomer is vinyl acetate and the monomer having a silyl group of formula (1) is vinyl trimethoxy silane.
